(19) United States
(12) Patent Application Publication
(10) Pub. No.: US 2017/0102063 A1
(43) Pub. Date: Apr. 13, 2017

(54) SEMI-ACTIVE TORQUE CANCELLATION SOLUTION

(71) Applicant: Dana Limited, Maumee, OH (US)

(72) Inventors: Mark R.J. Versteyhe, Oostkamp (BE); Laurens Van Eykeren, Adegem (BE); Jonas De Kooning, Kalmthout (BE)

(21) Appl. No.: 15/286,077

(22) Filed: Oct. 5, 2016

Related U.S. Application Data
(60) Provisional application No. 62/238,156, filed on Oct. 7, 2015.

(51) Int. Cl. F16H 57/00; F02B 75/06; F16H 53/06; F16F 15/31

(52) U.S. Cl. CPC F16H 57/0006; F16F 15/31; F02B 75/06; F16H 53/06; F16H 2057/0012

(57) ABSTRACT

A torque ripple compensation device for a motor vehicle. The device includes an outer ring, an inner ring and a linkage. A first end portion of the linkage is connected a constraint and a second end portion of the linkage is connected to the inner ring and the outer ring. A torque in a rotating shaft is compensated, reduced and/or canceled using the device by identifying a torque spike, calculating the amplitude and/or phase of the torque spike, comparing the amplitude and/or phase of the torque spike to a pre-determined torque profile, calculating the amount of amplitude and/or phase shift from the pre-determined torque profile, determining the amount of eccentricity and/or elliptical trajectory needed to compensate, reduce and/or cancel the amount of phase and/or amplitude shift, and applying a force to the first end portion of the linkage to compensate, reduce and/or cancel the phase and/or amplitude shift calculated.

### CROSS REFERENCE TO RELATED APPLICATIONS

The present application claims the benefit to U.S. Provisional Patent Application No. 62/238,156 filed on Oct. 7, 2015, which is incorporated herein by reference in its entirety.

### FIELD OF THE DISCLOSURE

The present invention relates to a semi-active torque cancellation solution that is used to eliminate torque spikes, torque ripples and/or torque pulses from a motor vehicle.

### BACKGROUND OF THE DISCLOSURE

There is a trend across the globe to decrease engine size as a result of recent improvements in combustion engine technology. The decreased engine size can be in terms of both smaller engine displacement and a reduced number of cylinders.

The improvements in engine technology result in more efficient vehicles. The efficiency may include increased fuel economy, better engine operation and reduced carbon dioxide emissions. A further advantage of smaller, but more powerful and efficient, engines is that vehicle manufactures can maintain the same vehicle body and vehicle performance characteristics that consumers are used to.

In some cases, the improvements are due to the use of superchargers and/or turbochargers. Superchargers and/or turbochargers increase the power output of the engine. Moreover, higher torque potential enables the use of longer gear ratios, which in turn makes down-speeding possible (i.e., operating at lower engine speeds). Downsizing, together with down-speeding, can be seen as one of the mainstream improvements in engine technology.

As mentioned above, vehicle performance characteristics with smaller, but more advanced engines can mirror vehicle characteristics when larger engines are used. A challenge associated with the smaller engine is when the engine is down-speeding an increase in the torque ripple at lower engine speeds can be experienced. The torque ripple at the engine output significantly rises with reduced idle speeds.

The torque ripple is caused by torque not being constantly delivered by the smaller internal combustion engine but is being delivered periodically during each power stroke. FIG. 1 graphically illustrates the torque that is being delivered during a conventional four-stroke cycle wherein section 2 is a power stroke, section 4 is an exhaust stroke, section 6 is an induction stroke, section 8 is a compression stroke and 10 is the mean torque. Additionally, as illustrated in FIG. 1 the power stroke 2 of the conventional four-stroke cycle experiences a maximum torque 12. As a result, the torque ripple occurs once every two turns of the crankshaft for each piston in the conventional four-stroke engine. A conventional four-cylinder engine will therefore have two torque ripples per turn while in contrast a conventional three-cylinder engine will have three torque ripples every two turns.

Torque ripples are not desirable because they can cause many problems within the vehicle such as increased stresses, increased wear and a large amount of vibrations on the components near the engine. All of these can cause damage to the powertrain of the vehicle and therefore results in poor vehicle drivability.

In order to improve the smooth operation and overall performance of the engine, the stress and vibrations associated with torque ripples must be compensated by an engine balancing method. On multi-cylinder engine configurations, there are several prior art options used to balance the engine eliminate stress and vibration.

In many conventional vehicles, the vibration and stress associated with the torque ripples are compensated by using flywheels and by using dampers and absorbers together. In some cases, a dual-mass flywheel mechanism is used wherein the inertia from the flywheel smoothens the rotational movement of the crankshaft, which keeps the engine running at a constant speed. FIG. 2 illustrates a schematic side view of a conventional flywheel based dampening system 20 for a conventional driveline.

An engine designer has to consider competing interests when employing the use of flywheels as the dampening system. A lighter flywheel will accelerate faster but loses its rotational speed quicker. In contrast, a heavier flywheel will be able to retain its rotational speed for a longer period of time but it will be more difficult to slow down. While the heavier flywheel will deliver smoother power, its size will make the engine less response which results in a reduction in the precision control of the engine of the vehicle. Regardless of whether or not a light or heavy flywheel is used, the flywheel solution may not be desirable because it adds too much weight to the vehicle driveline.

In addition to the weight of the flywheel systems, they have another disadvantage in that they are not adaptable to a variety of conditions. For example, flywheel systems are typically designed for the worst operating conditions which means they are sized to be large enough to dampen the largest vibrations at low speed. This means that they are over-dimensioned for higher speeds and will degrade the overall performance of the vehicle. Furthermore, not only is the amplitude of the torque ripples varying with speed and load, but also the phase of the torque ripple varies compared to the engine rotation. It would therefore be advantageous to develop a torque ripple compensation device that could be, passively or dynamically, adaptable both in amplitude and/or phase thereby always providing the best torque ripple attenuation while degrading the performance of the vehicle as little as possible. Additionally, it would be advantageous to develop a torque ripple compensation device where the amplitude torque and the phase torque can be controlled independently without the use of any springs.

Other systems are known to reduce or minimize engine torque ripples. In U.S. Patent Application Publication Number 2014-0261282, a device is proposed where a disk is placed at an angle using a cardan joint, to counteract cyclical torque ripples. In U.S. Patent Application Publication Number 2014-0260777, a device is proposed where a non-fixed inertia is moved to achieve a variable inertia to compensate for cyclical torque ripples. In U.S. Patent Application Publication Number 2014-0260778, a torsional compensating device is connected in parallel to the output axle of a combustion engine. Cyclical acceleration of the device applies a counteracting torque which can be adapted in amplitude and phase by changing the angles of the joints.

### SUMMARY OF THE DISCLOSURE

A torque ripple compensation device for a motor vehicle. The torque ripple compensation device includes an outer ring, an inner ring and a linkage. A first end portion of the linkage is connected a constraint and a second end portion of the linkage is connected to the inner ring and the outer ring of the torque ripple compensation device.

A torque in a rotating shaft is compensated, reduced and/or canceled using the torque ripple compensation device by identifying a torque spike, calculating the amplitude and/or phase of the torque spike, comparing the amplitude and/or phase of the torque spike to a pre-determined torque profile, calculating the amount of amplitude and/or phase shift from the pre-determined torque profile, determining the amount of eccentricity and/or elliptical trajectory needed to compensate, reduce and/or cancel the amount of phase and/or amplitude shift, and applying a force to the first end portion of the linkage to compensate, reduce and/or cancel the phase and/or amplitude shift calculated.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 is a graphical representation illustrating a torque output of a conventional four-stroke engine during a four-stroke cycle;

FIG. 2 is a schematic side view of a conventional flywheel based dampening system that is known in the prior art;

FIG. 3 is a partial side-view of a torque ripple compensation device according to an embodiment of the disclosure;

FIG. 4 schematically illustrates the concentric torque ripple compensation device linkage system according to an embodiment of the disclosure;

FIG. 5 illustrates how a torque ripple compensation device, according to an embodiment of the disclosure, controls the amount of amplitude torque cancellation;

FIG. 6 illustrates how a torque ripple compensation device, according to an embodiment of the disclosure, controls the amount of phase torque cancellation;

FIG. 7 is a schematic side-view of a portion of a vehicle having a torque ripple compensation device according to an embodiment of the disclosure;

FIG. 8 is a schematic side-view of a portion of a vehicle having a torque ripple compensation device according to another embodiment of the disclosure;

FIG. 9 is a schematic cross-sectional side view of a portion of a torque ripple compensation device, according to yet another embodiment of the disclosure;

FIG. 10 is a schematic cross-sectional side view of a torque ripple compensation device, according to still another embodiment of the disclosure when the torque ripple compensation device is in a first position;

FIG. 10a is a schematic cross-sectional side view of a roller guide when the torque ripple compensation device is in the first position illustrated in FIG. 10;

FIG. 11 is a schematic cross-sectional side view of the torque ripple compensation device of FIG. 10 in a second position;

FIG. 11a is a schematic cross-sectional side view of the roller guide when the torque ripple compensation device is in the second position illustrated in FIG. 11;

FIG. 12 is a schematic cross-sectional side view of the torque ripple compensation device of FIG. 10 in a third position;

FIG. 12a is a schematic cross-sectional side view of the roller guide when the torque ripple compensation device is in the third position illustrated in FIG. 12;

FIG. 13 is a schematic side-view of a portion of a vehicle having a torque ripple compensation device according to a further embodiment of the disclosure;

FIG. 14 is a schematic cross-sectional side view of a portion of a torque ripple compensation device, according to a further embodiment of the disclosure;

FIG. 15 is a schematic cross-sectional side view of a torque ripple compensation device, according to a further embodiment of the disclosure when the torque ripple compensation device is in a first position;

FIG. 15a is a schematic cross-sectional side view of a roller guide when the torque ripple compensation device is in the first position illustrated in FIG. 15;

FIG. 16 is a schematic cross-sectional side view of the torque ripple compensation device of FIG. 15 in a second position;

FIG. 16a is a schematic cross-sectional side view of the roller guide when the torque ripple compensation device is in the second position illustrated in FIG. 16;

FIG. 17 is a schematic cross-sectional side view of the torque ripple compensation device of FIG. 15 in a third position; and

FIG. 17a is a schematic cross-sectional side view of the roller guide when the torque ripple compensation device is in the third position illustrated in FIG. 17.

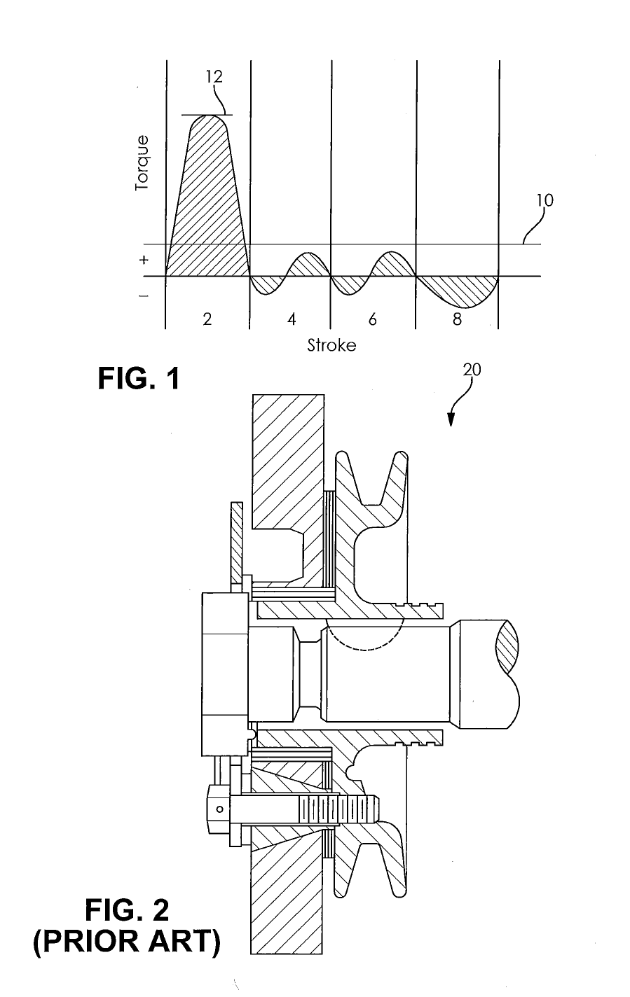

### DETAILED DESCRIPTION OF THE DISCLOSURE

It is to be understood that the invention may assume various alternative orientations and step sequences, except where expressly specified to the contrary. It is also understood that the specific devices and processes illustrated in the attached drawings, and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

The present disclosure relates to a torque ripple compensation device that is able to rotate around its axle and has an input section and an output section. The torque ripple compensation device according to the present disclosure is installed in a motor vehicle in series with a driveline of the vehicle. Additionally, the torque ripple compensation device is disposed between an engine flywheel and a transmission of the vehicle. According to a non-limiting example, the torque ripple compensation device may be designed as part of the transmission or the flywheel of the vehicle. Since the torque ripple compensation device is substantially cylindrical in shape, it can be easily fitted within the blue print of the vehicle driveline.

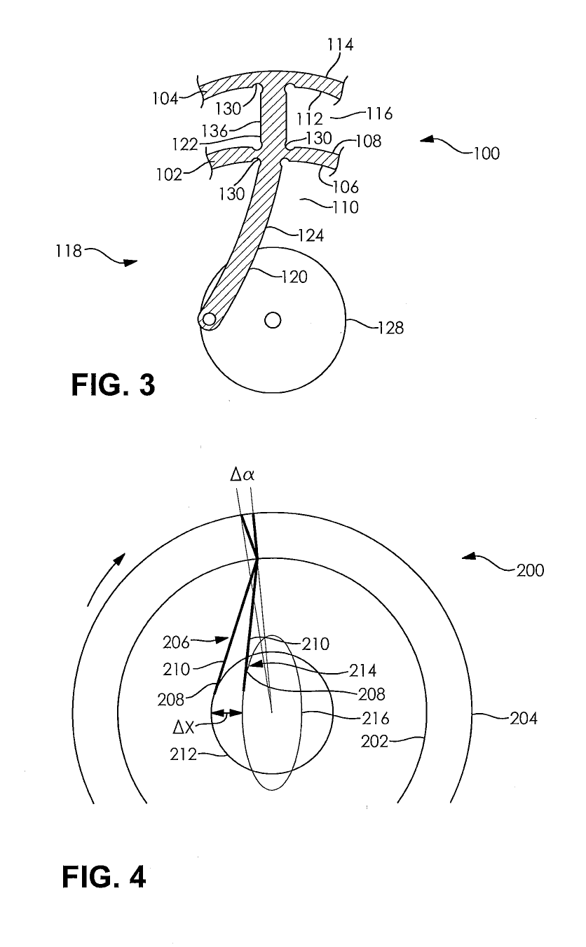

FIG. 3, is a schematic partial side view of a torque ripple compensation device 100 according to an embodiment of the disclosure. As illustrated in FIG. 3, the torque ripple compensation device 100 includes an inner ring 102 and an outer ring 104 that are able to rotate around a common axis. The inner ring 102 has an inner surface 106 and an outer surface 108 defining a hollow portion 110 therein. In a non-limiting example, the inner ring 102 may be made of steel, carbon fibre or the like.

Disposed radially outboard from the inner ring 102 is the outer ring 104 such that the outer ring 104 is concentric with the inner ring 102. Additionally, the outer ring 104 is co-axial with the inner ring 102. According to an alternative embodiment of the disclosure, at least a portion of the outer ring 104 is at least partially radially concentric with the inner ring 102. Similarly, the outer ring 104 has an inner surface 112 and an outer surface 114 defining a hollow portion 116 therein. In a non-limiting example, the outer ring 104 may be made of steel, carbon fibre or the like.

A linkage system 118 is used to link the inner ring 102 to the outer ring 104. The linkage system 118 allows for torque to be transferred between the inner ring 102 and the outer ring 104 of the torque ripple compensation device 100. According to a non-limiting example, the torque ripple compensation device 100 may include one or more linkage systems 118. In accordance with this embodiment, one or more of the one or more linkage systems 118 may be able to function as a lever. The linkage system 118 has a first end portion 120, a second end portion 122, a first segment 124 and a second segment 136. In a non-limiting example, the linkage system 118 may be made of steel, carbon fibre or the like.

At least a portion of the second end portion 122 of the linkage system 118 is integrally connected to the outer ring 104 and the inner ring 102 of the torque ripple compensation device 100. In direct contact with at least a portion of the first end portion 120 of the linkage system 118 is an inner constraint 128. In a non-limiting example, the inner constraint 128 is in direct contact with at least a portion of the first end portion 120 of the linkage system 118 by integrally connecting the first end portion 120 of the linkage system 118 to the inner constraint 128. Additionally, in a non-limiting example, the inner constraint 128 is in direct contact with at least a portion of the first end portion 120 of the linkage system 118 by allowing the first end portion 120 of the linkage system 118 to slide or drag against the inner constraint 128.

The constraint 128 is a mechanism which can transition from a substantially circular cross-sectional shape to a different shape thereby producing a different trajectory. In a non-limiting example, the constraint 128 is a mechanism which can be transitioned from a substantially circular cross-sectional shape to a substantially elliptical cross-sectional shape thereby producing a substantially elliptical trajectory. It is therefore understood that the constraint 128 according to the present disclosure, is a mechanism which can transition to any shape thereby providing any shape of trajectory necessary to compensate, reduce, and/or cancel any particular torque ripple. The trajectory to be followed can be implemented using one or more different mechanisms. In a non-limiting example, the one or more mechanisms of the constraint 128 is a cam shaft, an inverted cam shaft, a four-bar linkage system and/or a gear system that creates the required trajectory through a hypotrochoid, ellipsoidal and/or epitrochoid. As illustrated in FIG. 3, the constraint 128 is an inverted camshaft.

In order to prevent any backlash in the torque ripple compensation device 100 the mechanical linkage 118 can be attached to the inner ring 102 and/or the outer ring 104 by using one or more joints 130. As illustrated in FIG. 3 and according to an alternative embodiment of the disclosure, the structure of the inner ring 102, the outer ring 104 and the mechanical linkage 118 may narrow or have a reduced thickness at the one or more joints 130 to allow the structure of the torque ripple compensation device 100 to flex easier. The flexure may be up or down, side to side or orbital. In a non-limiting example, the one or more joints 130 of the mechanical linkage 128 that are used to attach the mechanical linkage 128 to the inner ring 102 and the outer ring 104 may be made of an elastic or a rubber material since the required angular deviation will be small. The flexible joints 130 allow a phase difference between the inner ring 102 and the outer ring 104 to be applied to the torque ripple compensation device 100. The order of magnitude: T_{d}/4ω²I, where T_{d} is the torque pulse magnitude, I is the inertia of the flywheel and ω² is the rotational speed of the shaft.

In normal operation, the linkage system 118 is such that the inner ring 102 and the outer ring 104 are fixed together and no angular difference exists between the inner ring 102 and the outer ring 104 over time. The principle underlying the present disclosure is based on enforcing an angular difference Δα(t) between the inner ring 104 and the outer ring 104 by operating the linkage system 118.

In order to obtain an optimum torque compensation, reduction and/or cancelation effect, a control system (not shown) is also used to control the torque ripple compensation device 100.

As illustrated in FIG. 4, the working principle underlying the present disclosure is based on creating a time-varying angular difference Δα(t) between the shaft connected to the engine and flywheel of the vehicle, and the input shaft of the vehicle transmission. The time-varying angular difference Δα(t) is based on the angular position of the crankshaft, as the torque pulses are related to this later quantity.

At the point in time when there is a torque spike, torque pulse and/or torque ripple, an angular difference Δα(t) is applied such that a torque peak can be absorbed by the flywheel inertia. It is to be understood that the torque peak is any torque experienced that is larger than a determined mean torque value. In other words, the system gives way to the flywheel to accelerate more than the driveline thereby absorbing the torque peak. In contrast, when the torque value is smaller than the mean torque value, an opposite angular difference is applied. In this case the flywheel is slowed down to recuperate some of its momentum in-order-to compensate for the lower torque value.

As previously discussed, FIG. 4 provides a schematic illustration of how the time varying angular difference Δα(t) can be generated according to an embodiment of the disclosure. Without limiting the scope of the disclosure, the following example is related to the use of a torque ripple compensation device 200 in a vehicle (not shown) having a four-cylinder engine (not shown). In accordance with this example, the inner ring 202 is connected to an output shaft (not shown) and an outer ring 204 is connected to an input shaft (not shown). In a non-limiting example, the output shaft (not shown) is a transmission input shaft and the input shaft (not shown) is an engine and/or flywheel shaft.

Integrally connected to both the inner ring 202 and the outer ring 204 is a bar-linkage. As illustrated in FIG. 4 and described in more detail below, FIG. 4 illustrates the bar-linkage in two different situations or positions according to an embodiment of the disclosure.

When the torque ripple compensation device 200 is in a first position or a first situation 206a first end portion 208 of a bar-linkage 210 is made to follow a substantially circular trajectory 212. In a non-limiting example, the bar-linkage 210 is a mechanical linkage, a cam shaft, an inverted cam shaft, a four-bar linkage system and/or a gear system that creates the required trajectory through a hypotrochoid and/or epitrochoid. In the first position or the first situation 206, both the inner ring 202 and the outer ring 204 have an equal rotational speed during a full rotation of the shaft and no time varying angular difference Δα(t) is induced.

In contrast, when the torque ripple compensation device 200 is in a second position or a second situation 214 the first end portion 208 of the bar-linkage 210 is made to follow a non-circular trajectory 216. In a non-limiting example, when the torque ripple compensation device 200 is in the second position or a second situation 214, the first end portion 208 of the bar-linkage 210 is made to follow an ellipsoidal trajectory. As illustrated in FIG. 4, ΔX represents the difference in the non-circular trajectory 216 in relation to the substantially circular trajectory 212 in the x-direction or the horizontal direction. As a result, ΔX represents the amount of eccentricity needed to cancel a torque spike, torque pulse and/or a torque ripple from the vehicle (not shown).

When the bar-linkage 210 is made for follow the non-circular trajectory 216, a time varying angular difference Δα(t) is induced which, as previously discussed, will compensate, reduce and/or cancel the torque spike, torque pulses and/or torque ripple. Additionally, the time varying angular difference Δα(t) will perform two oscillations per full rotation of the shaft thereby allowing the torque ripple compensation device 200 to compensate, reduce and/or cancel second order torque spikes, torque pulses and/or torque ripples experienced in the input shaft (not shown).

In order to obtain an optimum torque compensation, reduction and/or cancelation effect, a control system (not shown) is also used to control the torque ripple compensation device 200. The control system (not shown) needs two valves (not shown) to control the actuation system

The design of the trajectory to be followed by the linkage 210 is based on the type of engine, the order of the torque spikes, torque pulses and/or torque ripples to be compensated, reduced and/or cancelled along with the profile of the torque spikes, torque pulses and/or torque ripples to be compensated, reduced and/or cancelled.

The number of cylinders the engine (not shown) will determine the cyclic geometry symmetry of the trajectory. Without limiting the scope of the disclosure, the following examples concentrate on the compensation, reduction and/or cancellation of the first harmonic in the torque spikes, torque pulses and/or torque ripples. When using a four-cylinder, four-stroke engine, the trajectory needs to have a cyclic symmetry of 2, meaning for each full rotation of the crankshaft (not shown), the end of the linkage 210 will follow the same trajectory profile twice. In the situation where a six-cylinder, four-stroke engine is used, the trajectory needs to have a cyclic symmetry of 3. Finally, in the case where a three-cylinder, four-stroke engine is used, the trajectory needs to have a cyclic symmetry of 1.5, which means that the trajectory will need to be designed over two full rotations of the crankshaft (not shown).

The shape of the trajectory to be followed can be optimized according to the shape of the particular torque spikes, torque pulses and/or torque ripples in the engine (not shown) in-order-to achieve optimal compensation, reduction and/or cancellation. Furthermore, the profile necessary to compensate for the higher harmonics can be “added” to the base trajectory.

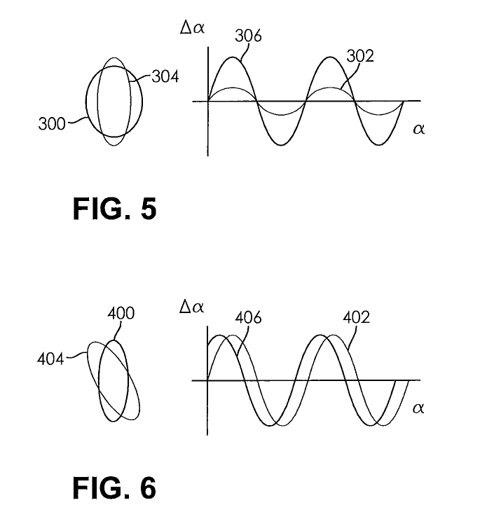

FIG. 5 illustrates how a torque ripple compensation device (not shown), according to an embodiment of the disclosure, controls the amount or the magnitude of amplitude torque cancellation. As the size, or the amplitude, of the torque spikes, torque ripples and/or torque pulses tends to decrease at higher revolutions per minute (rpms), it is essential to be able to control the magnitude or the amount of torque compensation, reduction and/or cancellation that is being performed by a torque ripple compensation device (not shown). Additionally, the magnitude of or the amount of amplitude torque that is compensated, reduced and/or cancelled is based on the angular position of the crankshaft and is therefore independent of the rotational speed of the crankshaft.

The amount or magnitude of the amplitude torque that is compensated, reduced and/or cancelled, can be controlled by the trajectory that is followed by a first end portion (not shown) of a linkage (not shown) of the torque ripple compensation device (not shown). Therefore, the amount or magnitude of amplitude torque compensation, reduction and/or cancellation is related to how close the trajectory followed by the first end portion (not shown) of the linkage (not shown) resembles that of a perfect circle. As illustrated in FIG. 5, the amount or degree of eccentricity of the trajectory followed by the first end portion (not shown) of the linkage (not shown) controls the amount or magnitude of the amplitude torque that is compensated, reduced and/or cancelled. This is referred to as the ability of the torque ripple compensation device (not shown) to perform amplitude control.

When the first end portion (not shown) of the linkage (not shown) torque ripple compensation device (not shown) is made to follow a trajectory 300 with a smaller amount or degree of eccentricity, the amount or magnitude of the amplitude torque 302 being compensated, reduced and/or cancelled is lower. In contrast, when the first end portion (not shown) of the linkage (not shown) is made to follow a trajectory 304 having a larger amount or degree of eccentricity, the amount or magnitude of the amplitude torque 306 being compensated, reduced and/or cancelled is higher.

FIG. 6 illustrates how a torque ripple compensation device (not shown), according to an embodiment of the disclosure, controls the amount or the magnitude of phase torque cancellation. In addition to the change in the amplitude of the torque spikes, torque pulses and/or torque ripples, the phase of the torque spikes, torque pulses and/or torque ripples can change with respect to the orientation of an engine (not shown) with changing rpms and engine loads.

The amount or magnitude of the phase torque that is compensated, reduced and/or cancelled, can be controlled by the orientation of the elliptical trajectory with respect to the orientation of the engine (not shown). Therefore, the amount or magnitude of phase torque compensation, reduction and/or cancellation is related to how close the orientation of the elliptical or non-circular trajectory is to the orientation of the engine (not shown). This is referred to as the ability of the torque ripple compensation device (not shown) to perform phase control.

As illustrated in FIG. 6, when for example, when the engine has an orientation 400 the torque spike, torque pulse and/or torque ripple has a phase 402. Additionally, when the linkage (not shown) of the torque ripple compensation device (not shown) has an orientation 404 the torque ripple compensation device (not shown) produces a torque spike, torque pulse and/or torque ripple 406. The greater the deviation of the orientation of the elliptical or non-circular trajectory followed by the linkage (not shown) from the orientation of the engine, the larger the magnitude of or amount of phase torque the torque ripple compensation device (not shown) can compensate, reduce and/or cancel.

As a result, the torque ripple compensation device according to the present disclosure is able to independently control the amplitude and/or the phase of a torque spike, torque pulse and/or a torque ripple.

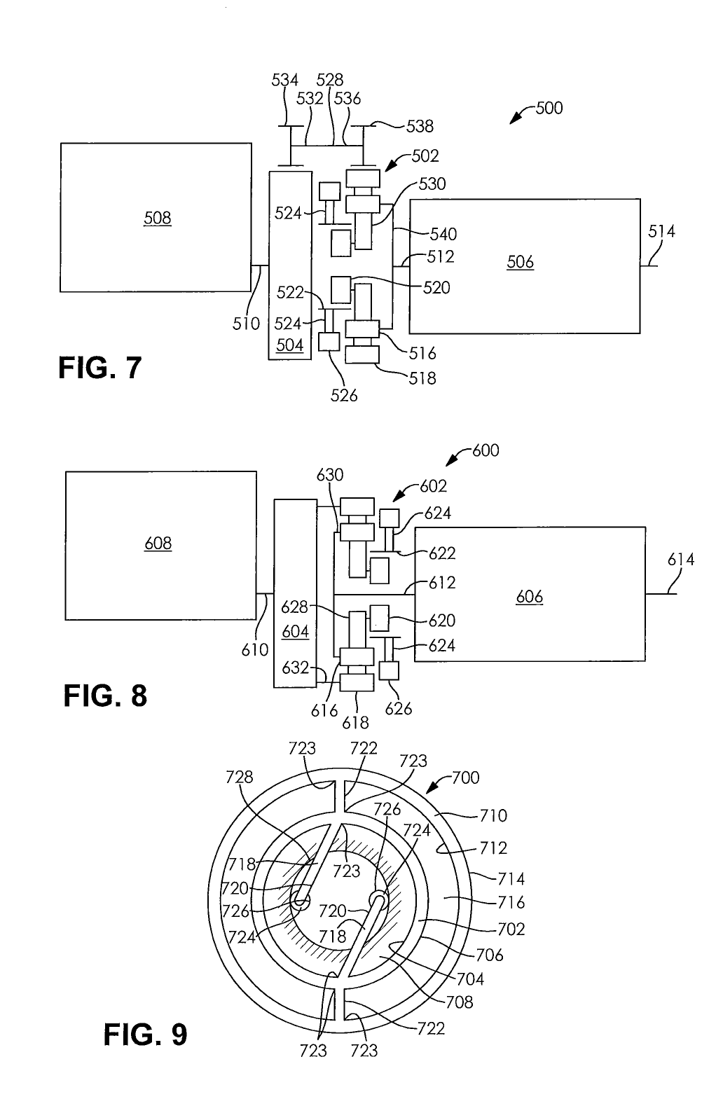

FIG. 7 is a schematic side-view of a portion of a vehicle 500 having a torque ripple compensation device 502 that is disposed between a flywheel 504 and a transmission 506. The vehicle 500 has an engine 508 that is drivingly connected to a side of the flywheel 504 via an engine output shaft 510. In a non-limiting example, the engine 508 may be drivingly connected to the flywheel 504 by using one or more of the following shafts (not shown): a coupling shaft, a stun shaft and/or a flywheel input shaft. The flywheel 504 is a rotating mechanism that is used to store rotational energy.

Drivingly connected to a side of the flywheel 504 opposite the engine output shaft 510 is a flywheel output shaft 512. In a non-limiting example, the flywheel 504 may be drivingly connected to the transmission 506 by using one or more of the following shafts (not shown): a transmission input shaft, a coupling shaft and/or a stub shaft. The transmission 506 is a power management system which provides controlled application of the rotational power provided by the engine 508 by means of a gearbox. Drivingly connected to an end of the transmission 506 opposite the flywheel output shaft 512 is a transmission output shaft 514.

The torque ripple compensation device 502, according to an embodiment of the disclosure, includes an inner ring 516, an outer ring 518, one or more rollers 520, one or more roller guides 522, one or more actuators 524, a rotating ring 526, a lay shaft 528 and one or more mechanical linkages 530. The inner ring 516 has a smaller diameter than the outer ring 518 such that the outer ring 518 is disposed radially outboard from the inner ring 516. Additionally, the inner ring 516 is co-axial with both the outer ring 518 and the flywheel output shaft 512. Furthermore, the inner ring 516 is at least partially radially concentric with the outer ring 518.

Integrally connecting the inner ring 516 of the torque ripple compensation device 502 to the outer ring 518 of the torque ripple compensation device 502 is the one or more mechanical linkages 530. An end of the one or more mechanical linkages 530 opposite the inner ring 516 and the outer ring 518 is directly connected to the one or more rollers 520. Additionally, the one or more mechanical linkages 530 extend radially transverse to the inner ring 516 and the outer ring 518 of the torque ripple compensation device 502. In a non-limiting example, the end of the one or more mechanical linkages 530 opposite the inner ring 516 and the outer ring 518 is connected to the one or more rollers 520 by using one or more of the following: a shaft, a linkage, a pin, a coupling shaft and/or a stub shaft.

According to an embodiment of the disclosure, the one or more rollers 520 are disposed axially outboard from the one or more mechanical linkages 530 such that the one or more rollers 520 are at least partially disposed between the one or more mechanical linkages 530 and the flywheel 504. According to an alternative embodiment of the disclosure (not shown), the one or more rollers are disposed axially inboard from the one or more mechanical linkages such that the one or more rollers are at least partially disposed between the one or more mechanical linkages and the transmission.

In direct contact with at least a portion of an outer surface of the one or more rollers 520 is the one or more roller guides 522. In a non-limiting example, the one or more roller guides 522 are one or more constraints, cam shafts, inverted cam shafts, four-bar linkage systems, gear systems and/or any other mechanisms which can impose a non-circular rotational trajectory on the end of the one or more mechanical linkages 530 opposite the inner ring 516 and the outer ring 518. As a non-limiting example, the non-circular trajectory is an ellipsoidal, a hypotrochoid and/or an epitrochoid trajectory.

In order to drive the one or more roller guides 522, the one or more actuators 524 are disposed radially outboard from the one or more roller guides 522. Additionally, the one or more actuators 524 are integrally connected to a side of the one or more roller guides 522 opposite the one or more rollers 520.

Disposed radially outboard from the one or more actuators 524 and integrally connected to an end of the one or more actuators 524 opposite the one or more roller guides 522, is the rotatable ring 526. Additionally, the rotatable ring 526 is co-axial with and at least partially radially concentric with the flywheel output shaft 512.

As illustrated in FIG. 7, the lay shaft 528 connects the outer ring 518 of the torque ripple compensation device 502 to the flywheel 504. Integrally connected to at least a portion of a first end portion 532 of the lay shaft 528 is a first gear 534 which drivingly connects the lay shaft 528 to the flywheel 504. According to an embodiment of the disclosure, at least a portion of an outer surface of the flywheel 504 includes a plurality of teeth (not shown) circumferentially extending from the outer surface of the flywheel 504. The plurality of teeth (not shown) extending from at least a portion of the outer surface of the flywheel 504 are complementary to and meshingly engaged with a plurality of teeth (not shown) circumferentially extending from at least a portion of an outer surface of the first gear 534.

Additionally, integrally connected to at least a portion of the second end portion 536 of the lay shaft 528 is a second gear 538 that drivingly connects the lay shaft 528 to the outer ring 518 of the torque ripple compensation device 502. According to an embodiment of the disclosure, at least a portion of an outer surface of the outer ring 518 of the torque ripple compensation device 502 includes a plurality of teeth (not shown) circumferentially extending from the outer surface of the outer ring 518. The plurality of teeth (not shown) extending from at least a portion of the outer surface of the outer ring 518 are complementary to and meshingly engaged with a plurality of teeth (not shown) circumferentially extending from at least a portion of an outer surface of the second gear 538.

Furthermore, as illustrated in FIG. 7, one or more inner ring connectors 540 integrally connects the inner ring 516 of the torque ripple compensation device 502 to the flywheel output shaft 512. As previously discussed, the flywheel 504 may be drivingly connected to the transmission 506 by using one or more of the following shafts (not shown): a transmission input shaft, a coupling shaft and/or a stub shaft. It is therefore understood that the one or more inner ring connectors 540 may be integrally connected to a transmission input shaft, a coupling shaft and/or a stub shaft.

According to an embodiment of the disclosure, the one or more inner ring connectors 540 are disposed axially inboard from the one or more mechanical linkages 530 such that at least a portion of the one or more inner ring connectors 540 are disposed between the one or more mechanical linkages 530 and the transmission 506. Additionally, according to yet another embodiment of the disclosure (not shown), the one or more inner ring connectors are disposed axially outboard from the one or more mechanical linkages such that at least a portion of the one or more inner ring connectors are disposed between the one or more mechanical linkages and the flywheel.

In order to obtain an optimum torque compensation, reduction and/or cancelation effect, a control system (not shown) is also used to control the torque ripple compensation device 502. The control system (not shown) requires the use of two valves (not shown) to control the one or more actuators 524 of the torque ripple compensation device 502. Additionally, the control system (not shown) includes the use of one or more sensors (not shown) to determine an instantaneous axle angle in relation to a chassis (not shown) of a vehicle 500 and a torque generated by the engine 508.

The instantaneous axle angle is measured by using a position sensor (not shown) that monitors a plurality of teeth passing on a flywheel gearing (not shown). Additionally, the torque generated by the engine 508 can be received using a Controller Area Network (CAN) (not shown) signal that is received from a motor Engine Control Unit (ECU) (not shown).

According to yet another embodiment of the disclosure (not shown) where the flywheel contains one or more springs that act as a damper, the torque generated by the engine can be determined by measuring the speed at an input and an output of the flywheel. In accordance with this embodiment of the disclosure (not shown), the torque generated by the engine is determined by using a spring stiffness of the flywheel and determining the amount of torque passing through the flywheel by determining the deflection between the input and the output of the flywheel.

FIG. 8 is a schematic side-view of a portion of a vehicle 600 having a torque ripple compensation device 602 that is disposed between a flywheel 604 and a transmission 606. The vehicle 600 has an engine 608 that is drivingly connected to a side of the flywheel 604 via an engine output shaft 610. In a non-limiting example, the engine 608 may be drivingly connected to the flywheel 604 by using one or more of the following shafts (not shown): a coupling shaft, a stun shaft and/or a flywheel input shaft. The flywheel 604 is a rotating mechanism that is used to store rotational energy.

Drivingly connected to a side of the flywheel 604 opposite the engine output shaft 610 is a flywheel output shaft 612. In a non-limiting example, the flywheel 604 may be drivingly connected to the transmission 606 by using one or more of the following shafts (not shown): a transmission input shaft, a coupling shaft and/or a stub shaft. The transmission 606 is a power management system which provides controlled application of the rotational power provided by the engine 608 by means of a gearbox. Drivingly connected to an end of the transmission 606 opposite the flywheel output shaft 612 is a transmission output shaft 614.

The torque ripple compensation device 602, according to an embodiment of the disclosure, includes an inner ring 616, an outer ring 618, one or more rollers 620, one or more roller guides 622, one or more actuators 624, a rotating ring 626 and one or more mechanical linkages 628. The inner ring 616 has a smaller diameter than the outer ring 618 such that the outer ring 618 is disposed radially outboard from the inner ring 616. Additionally, the inner ring 616 is co-axial with both the outer ring 618 and the flywheel output shaft 612. Furthermore, the inner ring 616 is at least partially radially concentric with the outer ring 618.

Integrally connecting the inner ring 616 of the torque ripple compensation device 602 to the outer ring 618 of the torque ripple compensation device 602 is the one or more mechanical linkages 628. An end of the one or more mechanical linkages 628 opposite the inner ring 616 and the outer ring 618 is directly connected to the one or more rollers 620. Additionally, the one or more mechanical linkages 628 extend radially transverse to the inner ring 616 and the outer ring 618 of the torque ripple compensation device 602. In a non-limiting example, the end of the one or more mechanical linkages 628 opposite the inner ring 616 and the outer ring 618 is connected to the one or more rollers 620 by using one or more of the following: a shaft, a linkage, a pin, a coupling shaft and/or a stub shaft.

According to an embodiment of the disclosure, the one or more rollers 620 are disposed axially inboard from the one or more mechanical linkages 628 such that the one or more rollers 620 are at least partially disposed between the one or more mechanical linkages 628 and the transmission 606. According to an alternative embodiment of the disclosure (not shown), the one or more rollers are disposed axially outboard from the one or more mechanical linkages such that the one or more rollers are at least partially disposed between the one or more mechanical linkages and the flywheel.

In direct contact with at least a portion of an outer surface of the one or more rollers 620 is the one or more roller guides 622. In a non-limiting example, the one or more roller guides 622 are one or more constraints, cam shafts, inverted cam shafts, four-bar linkage systems, gear systems and/or any other mechanisms which can impose a non-circular rotational trajectory on the end of the one or more mechanical linkages 628 opposite the inner ring 616 and the outer ring 618. As a non-limiting example, the non-circular trajectory is an ellipsoidal, a hypotrochoid and/or an epitrochoid trajectory.

In order to drive the one or more roller guides 622, the one or more actuators 624 are disposed radially outboard from the one or more roller guides 622. Additionally, the one or more actuators 624 are integrally connected to a side of the one or more roller guides 622 opposite the one or more rollers 620.

Disposed radially outboard from the one or more actuators 624 and integrally connected to an end of the one or more actuators 624 opposite the one or more roller guides 622, is the rotatable ring 626. Additionally, the rotatable ring 626 is co-axial with and at least partially radially concentric with the flywheel output shaft 612.

As illustrated in FIG. 8, one or more inner ring connectors 630 integrally connects the inner ring 616 of the torque ripple compensation device 602 to the flywheel output shaft 612. The one or more inner ring connectors 630 are disposed axially outboard from the one or more mechanical linkages 628 such that at least a portion of the one or more inner ring connectors 630 are disposed between the one or more mechanical linkages 628 and the flywheel 604. According to an alternative embodiment of the disclosure (not shown), the one or more inner ring connectors are disposed axially inboard from the one or more mechanical linkages such that at least a portion of the one or more inner ring connectors are disposed between the one or more mechanical linkages and the transmission.

Integrally connecting the outer ring 618 of the torque ripple compensation device 602 to the flywheel 604 is one or more outer ring connectors 632. One end of the one or more outer ring connectors 632 is integrally connected to at least a portion of the outer ring 616, and an end of the one or more outer ring connectors 632 opposite the outer ring 1018, is integrally connected to at least a portion of the flywheel 604. Additionally, the one or more outer ring connectors 632 are disposed axially outboard from the outer ring 616 of the torque ripple compensation device 602 such that at least a portion of the one or more outer ring connectors 632 is disposed between the outer ring 616 and the flywheel 604.

In order to obtain an optimum torque compensation, reduction and/or cancelation effect, a control system (not shown) is also used to control the torque ripple compensation device 602. The control system (not shown) requires the use of two valves (not shown) to control the one or more actuators 624 of the torque ripple compensation device 602. Additionally, the control system (not shown) includes the use of one or more sensors (not shown) to determine an instantaneous axle angle in relation to a chassis (not shown) of a vehicle 600 and a torque generated by the engine 608.

The instantaneous axle angle is measured by using a position sensor (not shown) that monitors a plurality of teeth passing on a flywheel gearing (not shown). Additionally, the torque generated by the engine 608 can be received using a Controller Area Network (CAN) (not shown) signal that is received from a motor Engine Control Unit (ECU) (not shown).

According to yet another embodiment of the disclosure (not shown) where the flywheel contains one or more springs that act as a damper, the torque generated by the engine can be determined by measuring the speed at an input and an output of the flywheel. In accordance with this embodiment of the disclosure (not shown), the torque generated by the engine is determined by using a sprig stiffness of the flywheel and determining the amount of torque passing through the flywheel by determining the deflection between the input and the output of the flywheel.

FIG. 9 is a schematic illustration of a cross-sectional side view of a portion of a torque ripple compensation device 700 according to an embodiment of the disclosure. The torque ripple compensation device 700 has an inner ring 702 having an inner surface 704 and an outer surface 706 defining a hollow portion 708 therein. In a non-limiting example, the inner ring 702 is made of steel, carbon fibre or the like. At least a portion of the inner ring 702 of the torque ripple compensation device 700 is integrally connected to at least a portion of one or more of the following (not shown): a flywheel, a transmission, a flywheel output shaft, a transmission input shaft, a coupling shaft and/or a stub shaft.

Disposed radially outboard from and co-axial with the inner ring 702 is an outer ring 710 having an inner surface 712 and an outer surface 714 defining a hollow portion 716 therein. In a non-limiting example, the outer ring 710 is made of steel, carbon fibre or the like. The outer ring 710 of the torque ripple compensation device 700 is at least partially radially concentric with the inner ring 702 of the torque ripple compensation device 700. Additionally, as illustrated in FIG. 9, the outer ring 710 has a larger diameter than the inner ring 702. Furthermore, at least a portion of the outer ring 710 of the torque ripple compensation device 700 is integrally connected to at least a portion of one or more of the following (not shown): a flywheel, a transmission, a flywheel output shaft, a transmission input shaft, a coupling shaft and/or a stub shaft.

Integrally connected to the inner ring 702 and the outer ring 710 of the torque ripple compensation device 700 is one or more mechanical linkages 718 having a first end portion 720 and a second end portion 722. In a non-limiting example, the one or more mechanical linkages 718 are made of steel, carbon fibre or the like. As illustrated in FIG. 9, at least a portion of the second end portion 722 of the one or more mechanical linkages 718 are integrally connected to the inner ring 702 and the outer ring 710 of the torque ripple compensation device 700. The one or more mechanical linkages 718 mechanically connects the inner ring 702 to the outer ring 710 of the torque ripple compensation device 700. Additionally, the one or more mechanical linkages 718 extend radially inboard from the inner ring 702 and/or the outer ring 710 of the torque ripple compensation device 700. According to an embodiment of the disclosure, the one or more mechanical linkages 718 are disposed radially transverse to the inner ring 702 and the outer ring 710 of the torque ripple compensation device 700.

According to one embodiment of the disclosure, the one or more mechanical linkages 718 are connected to the inner ring 702 and the outer ring 710 of the torque ripple compensation device 700 by using one or more flexible joints 723. According to an alternative embodiment of the disclosure (not shown) the structure of the inner ring, the outer ring and/or the one or more mechanical linkages may narrow or have a reduced thickness at the one or more flexible joints thereby allowing the structure of the torque ripple compensation device to flex easier. The flexure may be up or down, side to side or orbital. In a non-limiting example, the one or more flexible joints 723 may be made of an elastic or a rubber material since the required angular deviation will be small. The one or more flexible joints 723 allow a phase difference between the inner ring 702 and the outer ring 710 to be applied to the torque ripple compensation device 700.

At least a portion of the first end portion 720 of the one or more mechanical linkages 718 are directly connected to one or more rollers 724. In a non-limiting example, the first end portion 720 of the one or more linkages 718 are connected to the one or more rollers 724 by using one or more of the following: a shaft, a linkage, a pin, a coupling shaft and/or a stub shaft. The one or more rollers 724 are substantially circular in shape however; it is within the scope of this disclosure that the one or more rollers 724 may be any shape that will aid in imposing a non-circular trajectory on the first end portion 720 of the one or more mechanical linkages 718. According to an embodiment of the disclosure, the one or more rollers 724 are rotatively connected to at least a portion of the first end portion 720 of the one or more mechanical linkages 718.

At least a portion of an outer surface 726 of the one or more rollers 724 is in direct contact with one or more roller guides 728. The one or more roller guides 728 provide the outermost path that the one or more rollers 724 can follow, thereby defining the trajectory that the one or more rollers 724 will follow in operation. In a non-limiting example, the one or more roller guides 728 are one or more constraints, cam shafts, inverted cam shafts, four-bar linkage systems, gear systems and/or any other mechanisms which can impose a non-circular rotational trajectory on the first end portion 720 of the one or more mechanical linkages 718. As a non-limiting example, the non-circular trajectory is an ellipsoidal, a hypotrochoid and/or an epitrochoid trajectory.

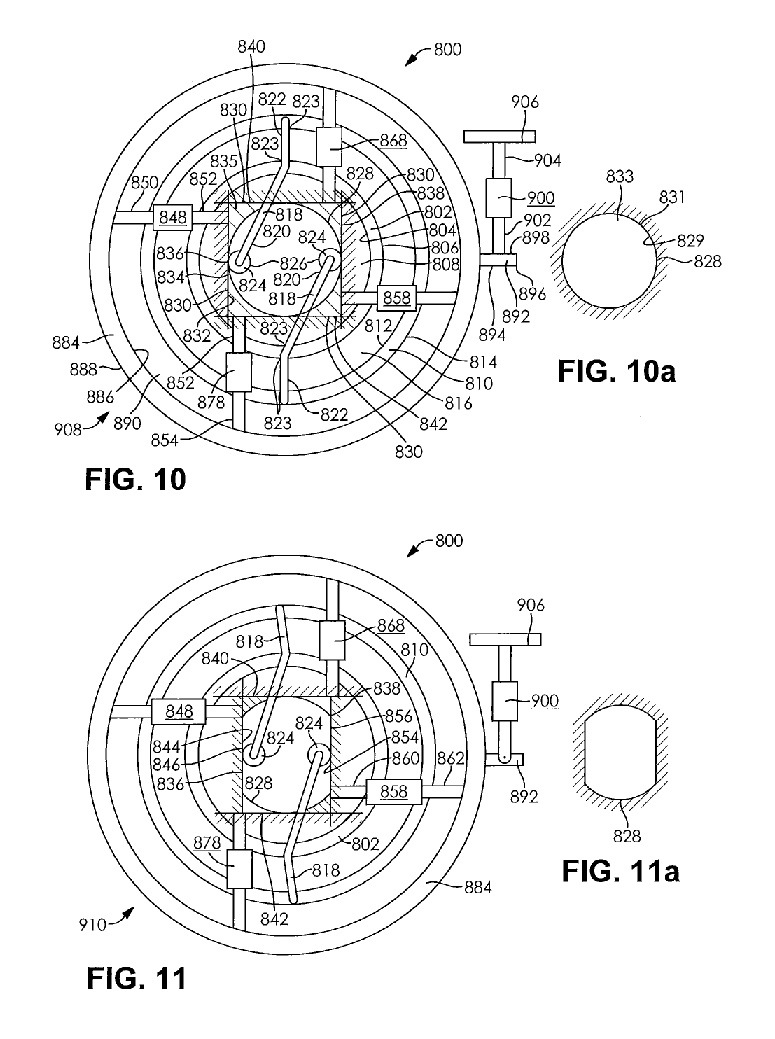

FIGS. 10, 11 and 12 provide a schematic cross-sectional side view of a torque ripple compensation device 800, according to still another embodiment of the disclosure. As illustrated in FIGS. 10, 11 and 12, the torque ripple compensation device 800 includes an inner ring 802 having an inner surface 804 and an outer surface 806 defining a hollow portion 808 therein. In a non-limiting example, the inner ring 802 is made of steel, carbon fibre or the like. At least a portion of the inner ring 802 of the torque ripple compensation device 800 is integrally connected to at least a portion of one or more of the following (not shown): a flywheel, a transmission, a flywheel output shaft, a transmission input shaft, a coupling shaft and/or a stub shaft.

Disposed radially outboard from and co-axial with the inner ring 802 is an outer ring 810 having an inner surface 812 and an outer surface 814 defining a hollow portion 816 therein. In a non-limiting example, the outer ring 810 is made of steel, carbon fibre or the like. The outer ring 810 of the torque ripple compensation device 800 is at least partially radially concentric with the inner ring 802 of the torque ripple compensation device 800. Additionally, as illustrated in FIGS. 10, 11 and 12, the outer ring 810 has a larger diameter than the inner ring 802. Furthermore, at least a portion of the outer ring 810 of the torque ripple compensation device 800 is integrally connected to at least a portion of one or more of the following (not shown): a flywheel, a transmission, a flywheel output shaft, a transmission input shaft, a coupling shaft and/or a stub shaft.

Integrally connected to the inner ring 802 and the outer ring 810 of the torque ripple compensation device 800 is one or more mechanical linkages 818 having a first end portion 820 and a second end portion 822. In a non-limiting example, the one or more mechanical linkages 818 are made of steel, carbon fibre or the like. As illustrated in FIGS. 10, 11 and 12, at least a portion of the second end portion 822 of the one or more mechanical linkages 818 is integrally connected to the inner ring 802 and the outer ring 810 of the torque ripple compensation device 800. The one or more mechanical linkages 818 mechanically connects the inner ring 802 to the outer ring 810 of the torque ripple compensation device 800. Additionally, the one or more mechanical linkages 818 extend radially inboard from the inner ring 802 and/or the outer ring 810 of the torque ripple compensation device 800. According to an embodiment of the disclosure, the one or more mechanical linkages 818 are disposed radially transverse to the inner ring 802 and the outer ring 810 of the torque ripple compensation device 800.

According to one embodiment of the disclosure, the one or more mechanical linkages 818 are connected to the inner ring 802 and the outer ring 810 of the torque ripple compensation device 800 by using one or more flexible joints 823. According to an alternative embodiment of the disclosure (not shown) the structure of the inner ring, the outer ring and/or the one or more mechanical linkages may narrow or have a reduced thickness at the one or more flexible joints thereby allowing the structure of the torque ripple compensation device to flex easier. The flexure may be up or down, side to side or orbital. In a non-limiting example, the one or more flexible joints 823 may be made of an elastic or a rubber material since the required angular deviation will be small. The one or more flexible joints 823 allow a phase difference between the inner ring 802 and the outer ring 810 to be applied to the torque ripple compensation device 800.

At least a portion of the first end portion 820 of the one or more mechanical linkages 818 are directly connected to one or more rollers 824. According an alternative embodiment of the disclosure, the one or more rollers 824 are also axially offset from the inner ring 802, the outer ring 810 and/or the one or more mechanical linkages 818. In a non-limiting example, the first end portion 820 of the one or more linkages 818 are connected to the one or more rollers 824 by using one or more of the following: a shaft, a linkage, a pin, a coupling shaft and/or a stub shaft. The one or more rollers 824 are substantially circular in shape however; it is within the scope of this disclosure that the one or more rollers 824 may be any shape that will aid in imposing a non-circular trajectory on the first end portion 820 of the one or more mechanical linkages 818. Additionally, according to an embodiment of the disclosure, the one or more rollers 824 are rotatively connected to at least a portion of the first end portion 820 of the one or more mechanical linkages 818.

At least a portion of an outer surface 826 of the one or more rollers 824 is in direct contact with one or more roller guides 828 having an inner surface 829 and an outer surface 831 defining a hollow portion 833 therein. As illustrated in FIGS. 10, 11 and 12, at least a portion of the outer surface 824 of the one or more rollers 824 are in direct contact with at least a portion of the inner surface 829 of the one or more roller guides 828. According to an alternative embodiment of the disclosure, the one or more roller guides 828 are also axially offset from the inner ring 802, the outer ring 810 and/or the one or more mechanical linkages 818. The one or more roller guides 828 provide the outermost path that the one or more rollers 824 can follow, thereby defining the trajectory that the one or more rollers 824 and/or the first end portion 820 of the one or more mechanical linkages 818 will follow in operation. In a non-limiting example, the one or more roller guides 828 are one or more constraints, cam shafts, inverted cam shafts, four-bar linkage systems, gear systems and/or any other mechanisms which can impose a non-circular rotational trajectory on the first end portion 820 of the one or more mechanical linkages 818. As a non-limiting example, the non-circular trajectory is an ellipsoidal, a hypotrochoid and/or an epitrochoid trajectory.

In direct contact with at least a portion of the outer surface 831 of the one or more roller guides 828 is one or more constraints 830 having an inner surface 832 and an outer surface 834 defining a hollow portion 835 therein. According to an alternative embodiment of the disclosure, the one or more constraints 830 are also axially offset from the inner ring 802, the outer ring 810 and/or the one or more mechanical linkages 818. As it can be seen by referencing FIGS. 10, 11 and 12, the inner surface 832 of the one or more constraints 830 is in direct contact with at least a portion of the outer surface 831 of the one or more roller guides 828.

As illustrated in FIGS. 10, 11 and 12, and according to an embodiment of the disclosure, the torque ripple compensation device 800 includes four constraints 830 including a first vertical constraint 836 a second vertical constraint 838, a first horizontal constraint 840 and a second horizontal constraint 842.

The first vertical constraint 836 has an inner surface 844 and an outer surface 846 and is horizontally or axially movable by one or more first axial actuators 848 having a first end portion 850 and a second end portion 852. At least a portion of the inner surface 844 of the first vertical constraint 836 is in direct contact with at least a portion of the outer surface 831 of the one or more roller guides 828. Additionally, at least a portion of the outer surface 846 of the first vertical constraint 836 is integrally connected to at least a portion of the second end portion 852 of the one or more first axial actuators 848. The one or more first axial actuators 848 are substantially horizontal in relation to the first vertical constraint 836 such that the one or more first axial actuators 848 are substantially perpendicular to the first vertical constraint 836. According to an alternative embodiment of the disclosure, the one more first axial actuators 848 are axially offset from the inner ring 802, the outer ring 810 and/or the one or more mechanical linkages 818.

As illustrated in FIGS. 10, 11 and 12, the second vertical constraint 838 has an inner surface 854 and an outer surface 856 and is horizontally or axially movable by one or more second axial actuators 858 having a first end portion 860 and a second end portion 862. At least a portion of the inner surface 854 of the second vertical constraint 838 is in direct contact with at least a portion of the outer surface 831 of the one or more roller guides 828. Additionally, at least a portion of the outer surface 856 of the second vertical constraint 838 is integrally connected to at least a portion of the first end portion 860 of the one or more second horizontal actuators 858. The one or more second axial actuators 858 are substantially horizontal in relation to the second vertical constraint 838 such that the one or more second axial actuators 858 are substantially perpendicular to the second vertical constraint 838. Furthermore, vertical constraints 836 and 838 are disposed on axially opposing sides of the one or more roller guides 828 and are substantially parallel to each other. According to an alternative embodiment of the disclosure, the one or more second axial actuators 858 are axially offset from the inner ring 802, the outer ring 810 and/or the one or more mechanical linkages 818.

The first horizontal constraint 840 has an inner surface 864 and an outer surface 866 and is vertically or radially movable by one or more first radial actuators 868 having a first end portion 870 and a second end portion 872. At least a portion of the inner surface 864 of the first horizontal constraint 840 is in direct contact with at least a portion of the outer surface 831 of the one or more roller guides 828. Additionally, at least a portion of the outer surface 866 of the first horizontal constraint 840 is integrally connected to at least a portion of the second end portion 872 of the one or more first radial actuators 868. The one or more first radial actuators 868 are substantially vertical in relation to the first horizontal constraint 840 such that the one or more first radial actuators 868 are substantially perpendicular to the first horizontal constraint 840. According to an alternative embodiment of the disclosure, the one or more first radial actuators 868 are axially offset from the inner ring 802, the outer ring 810 and/or the one or more mechanical linkages 818.

As illustrated in FIGS. 10, 11 and 12, the second horizontal constraint 842 has an inner surface 874 and an outer surface 876 and is vertically or radially movable by one or more second radial actuators 878 having a first end portion 880 and a second end portion 882. At least a portion of the inner surface 874 of the second horizontal constraint 842 is in direct contact with at least a portion of the outer surface 831 of the one or more roller guides 828. Additionally, at least a portion of the outer surface 876 of the second horizontal constraint 842 is integrally connected to at least a portion second end portion 882 of the second radial actuator 878. The one or more second radial actuators 878 are substantially vertical in relation to the second horizontal constraint 842 such that the one or more second radial actuators 878 are substantially perpendicular to the second horizontal constraint 842. Furthermore, horizontal constraints 840 and 842 are disposed on radially opposing sides of the one or more roller guides 828 and are substantially parallel to each other. According to an alternative embodiment of the disclosure, the one or more first radial actuators 868 are axially offset from the inner ring 802, the outer ring 810 and/or the one or more mechanical linkages 818.

Co-axial with but at least partially axially offset from the inner ring 802 and the outer ring 810 is a rotatable ring 884 having an inner surface 886 and an outer surface 888 defining a hollow portion 890 therein. At least a portion of the first end portion 850 of the one or more first axial actuator 848 and at least a portion of the second end portion 862 of the one or more second axial actuator 858 is integrally connected to at least a portion of the inner surface 886 of the rotatable ring 884. Similarly, at least a portion of the first end portion 870 of the one or more first radial actuators 868 and at least a portion of the first end portion 880 of the one or more second radial actuators 878 are integrally connected to at least a portion of the inner surface 886 of the rotatable ring 884.

According to an alternative embodiment of the disclosure (not shown), the one or more first axial actuators, second axial actuators, first radial actuators and/or second radial actuators are integrally connected to the one or more roller guides without the use of the first vertical constraint, the second vertical constraint, the first horizontal constraint and/or the second horizontal constraint.

A rotatable ring connector 892 having a first end portion 894, a second end portion 896 and an outer surface 898 is integrally connected to at least a portion of the outer surface 888 of the rotatable ring 884. As illustrated in FIGS. 10, 11 and 12, at least a portion of the first end portion 894 of the rotatable ring connector 892 is integrally connected to at least a portion of the outer surface 888 of the rotatable ring 884.

In order to rotate the rotatable ring, a rotatable ring rotating device is used. According to an embodiment of the disclosure, the rotatable ring rotating device is an orientation actuator 900 having a first end portion 902 and a second end portion 904. As illustrated in FIGS. 10, 11 and 12, at least a portion of the first end portion 902 of the orientation actuator 900 is integrally connected to at least a portion of the outer surface 898 of the rotatable ring connector 892. According to an embodiment of the disclosure, the first end portion 902 of the orientation actuator 900 is pivotally connected to at least a portion of the outer surface 898 or the rotatable ring connector 892. The second end portion 904 of the orientation actuator 900 is integrally connected to a portion of a vehicle chassis 906. According to an embodiment of the disclosure, the second end portion 904 of the orientation actuator 900 is pivotally connected to at least a portion of the vehicle chassis 906.

In accordance with an alternative embodiment of the disclosure (not shown), at least a portion of the first end portion of the orientation actuator is integrally connected to at least a portion of the outer surface of the rotatable ring. According to yet another embodiment of the disclosure (not shown), at least a portion of the first end portion of the orientation actuator is pivotally connected to at least a portion of the outer surface of the rotatable ring. Furthermore, in accordance with still another embodiment of the disclosure (not shown), the rotatable ring rotating device is not the orientation actuator previously discussed, but is an electric motor that acts upon at least a portion of the outer surface of the rotatable ring to rotate the rotatable ring.

According to yet another alternative embodiment of the disclosure (not shown), the rotatable ring is not rotatable. In accordance with this embodiment of the disclosure (not shown), at least a portion of the outer surface of the rotatable ring is integrally connected to at least a portion of the chassis of the vehicle.

When the torque ripple compensation device 800 is in a first position 908 illustrated in FIG. 10, the first vertical constraint 836, the second vertical constraint 838, the first horizontal constraint 840 and the second horizontal constraint 842 are not acting upon the one or more roller guides 828 and/or the one or more rollers 824. According to an embodiment of the disclosure, when in the first position 908, the one or more first axial actuators 848, the one or more second axial actuators 858, the one or more first radial actuators 868 and the one or more second radial actuators 878 are fully retracted and in their home position. As illustrated in FIGS. 10 and 10a, when the first vertical constraint 836, the second vertical constraint 838, the first horizontal constraint 840 and the second horizontal constraint 842 are not acting upon the one or more rollers 824, the one or more roller guides 828 have a substantially circular shape. As a result, the shape of the trajectory of the first end portion 820 of the one or more mechanical linkages 818 is not altered and a zero angular difference is imposed between the inner ring 802 and the outer ring 810 thereby resulting in zero torque spike, torque pulse and/or torque ripple compensation, reduction and/or cancelation.

In contrast, when the torque ripple compensation device 800 is in a second position 910 illustrated in FIG. 11, the one or more first axial actuators 848 and/or the one or more second axial actuators 858 extend thereby acting upon the one or more rollers 824 and/or the first end portion 820 of the one or more mechanical linkages 818. As illustrated in FIGS. 11 and 11a, when the first and the second vertical constraints 836 and 838 are acting upon the one or more roller guides 828 and/or the one or more rollers 824, the one or more roller guides 828 have a non-circular shape. As a result, the shape of the trajectory of the first end portion 820 of the one or more mechanical linkages 818 is altered and a non-zero angular difference Δα(t) is imposed between the inner ring 802 and the outer ring 810 thereby resulting in amplitude torque spike, torque pulse and/or torque ripple compensation, reduction and/or cancelation.

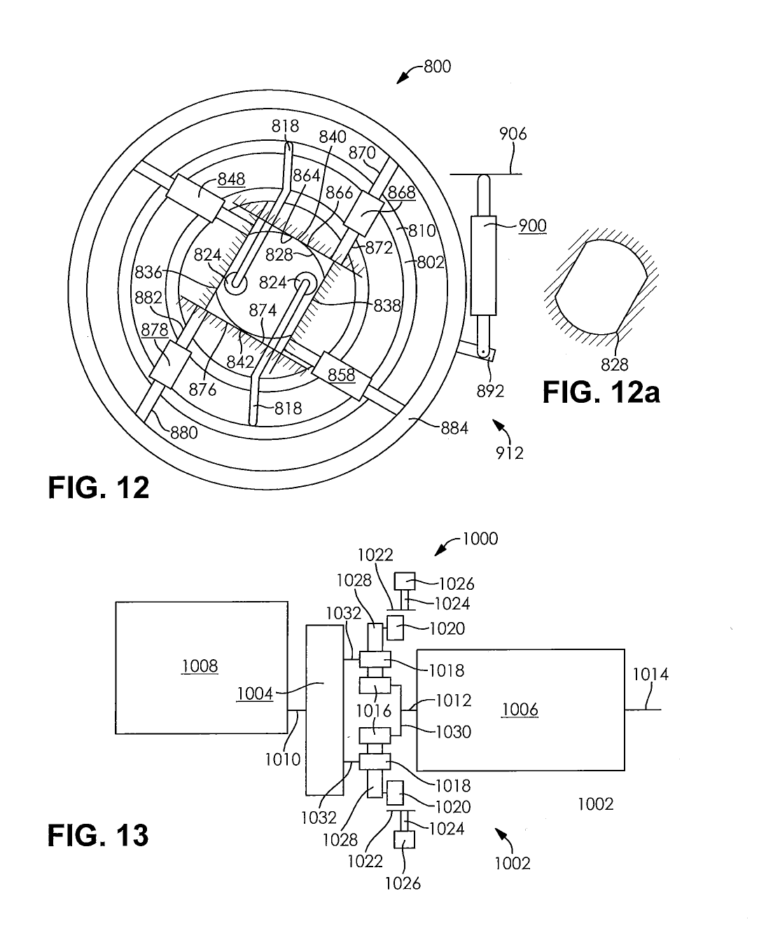

Finally, when the torque ripple compensation device 800 is in a third position 912 illustrated in FIG. 12, the one or more first axial actuators 848 and/or the one or more second axial actuators 858 extend thereby acting upon the one or more rollers 824 and/or the first end portion 820 of the one or more mechanical linkages 818. Additionally, when in the third position 912, the orientation actuator 900 extends and rotates the rotatable ring 884 thereby altering the orientation of the first and second vertical constraints 836 and 838, the first and second horizontal constraints 840 and 842, the one or more first and second axial actuators 848 and 858, the one or more first and second radial actors 868 and 878 and/or the one or more roller guides 828 imposing a phase angle.

As illustrated in FIGS. 12 and 12a, when the first and second vertical constraints 836 and 838 are acting upon the one or more roller guides 828 and/or the one or more rollers 824 of the one or more mechanical linkages 818, the one or more roller guides 828 have a non-circular shape. Furthermore, when the orientation actuator 900 extends and rotates the rotatable ring 884, it alters the orientation of the one or more roller guides 828. As a result, the shape and the orientation of the trajectory of the first end portion 820 of the one or more mechanical linkages 818 is altered and a non-zero angular difference Δα(t) is imposed between the inner ring 802 and the outer ring 810 thereby resulting in both amplitude and phase torque spike, torque pulse and/or torque ripple compensation, reduction and/or cancelation.

It is within the scope of the present disclosure that the first and second vertical constraints 836 and 838, the first and second horizontal constraints 840 and 842 and/or the orientation actuator 900 may independently or in combination act upon the one or more roller guides 828 and/or the one or more rollers 824 of the first end portion 820 of the one or more mechanical linkages 818. As a result, the torque ripple compensation device 800 according to the present disclosure, is able to impose any non-circular trajectory on and/or alter the orientation of the trajectory of the first end portion 820 of the one or more linkages 818. This allows the torque ripple compensation device 800 to independently control both the amplitude and/or the phase of a torque spike, torque pulse and/or a torque ripple.

In order to obtain an optimum torque compensation, reduction and/or cancelation effect, a control system (not shown) is also used to control the torque ripple compensation device 800. The control system (not shown) requires the use of two valves (not shown) to control the one or more actuators 848, 858, 868, 878 and 900 of the torque ripple compensation device 800. Additionally, the control system (not shown) includes the use of one or more sensors (not shown) to determine an instantaneous axle angle in relation to a chassis (not shown) of a vehicle (not shown) and a torque generated by the engine (not shown).

The instantaneous axle angle is measured by using a position sensor (not shown) that monitors a plurality of teeth passing on a flywheel gearing (not shown). Additionally, the torque generated by the engine (not shown) can be received using a Controller Area Network (CAN) (not shown) signal that is received from a motor Engine Control Unit (ECU) (not shown).

According to yet another embodiment of the disclosure (not shown) where the flywheel contains one or more springs that act as a damper, the torque generated by the engine can be determined by measuring the speed at an input and an output of the flywheel. In accordance with this embodiment of the disclosure (not shown), the torque generated by the engine is determined by using a sprig stiffness of the flywheel and determining the amount of torque passing through the flywheel by determining the deflection between the input and the output of the flywheel.

FIG. 13 is a schematic side-view of a portion of a vehicle 1000 having a torque ripple compensation device 1002 that is disposed between a flywheel 1004 and a transmission 1006. The vehicle 1000 has an engine 1008 that is drivingly connected to a side of the flywheel 1004 via an engine output shaft 1010. In a non-limiting example, the engine 1008 may be drivingly connected to the flywheel 1004 by using one or more of the following (not shown): a coupling shaft, a stun shaft and/or a flywheel input shaft. The flywheel 1004 is a rotating mechanism that is used to store rotational energy.

Drivingly connected to a side of the flywheel 1004 opposite the engine output shaft 1010 is a flywheel output shaft 1012. In a non-limiting example, the flywheel 1004 may be drivingly connected to the transmission 1006 by using one or more of the following shafts (not shown): a transmission input shaft, a coupling shaft and/or a stub shaft. The transmission 1006 is a power management system which provides controlled application of the rotational power provided by the engine 1008 by means of a gearbox. Drivingly connected to an end of the transmission 1006 opposite the flywheel output shaft 1012 is a transmission output shaft 1014.

The torque ripple compensation device 1002, according to an embodiment of the disclosure, includes an inner ring 1016, an outer ring 1018, one or more rollers 1020, one or more roller guides 1022, one or more actuators 1024, a rotating ring 1026 and one or more mechanical linkages 1028. The inner ring 1016 has a smaller diameter than the outer ring 1018 such that the outer ring 1018 is disposed radially outboard from the inner ring 1016. Additionally, the inner ring 1016 is co-axial with both the outer ring 1018 and the flywheel output shaft 1012. Furthermore, the inner ring 1016 is at least partially radially concentric with the outer ring 1018.

Integrally connecting the inner ring 1016 of the torque ripple compensation device 1002 to the outer ring 1018 of the torque ripple compensation device 1002 is the one or more mechanical linkages 1028. An end of the one or more mechanical linkages 1028 opposite the inner ring 1016 and the outer ring 1018 is directly connected to the one or more rollers 1020. Additionally, the one or more mechanical linkages 1028 extends radially outboard from the inner ring 1016 and the outer ring 1018 away from the flywheel output shaft 1012. Furthermore, the one or more mechanical linkages 1028 extend radially transverse to the inner ring 1016 and the outer ring 1018 of the torque ripple compensation device 1002. In a non-limiting example, the end of the one or more mechanical linkages 1028 opposite the inner ring 1016 and the outer ring 1018 is connected to the one or more rollers 1020 by using one or more of the following: a shaft, a linkage, a pin, a coupling shaft and/or a stub shaft.

According to an embodiment of the disclosure, the one or more rollers 1020 are disposed axially inboard from the one or more mechanical linkages 1028 such that the one or more rollers 1020 are at least partially disposed between the one or more mechanical linkages 1028 and the transmission 1006. According to an alternative embodiment of the disclosure (not shown), the one or more rollers are disposed axially outboard from the one or more mechanical linkages such that the one or more rollers are at least partially disposed between the one or more mechanical linkages and the flywheel.

In direct contact with at least a portion of an outer surface of the one or more rollers 1020 is the one or more roller guides 1022. In a non-limiting example, the one or more roller guides 1022 are one or more constraints, cam shafts, inverted cam shafts, four-bar linkage systems, gear systems and/or any other mechanisms which can impose a non-circular rotational trajectory on the end of the one or more mechanical linkages 1028 opposite the inner ring 1016 and the outer ring 1018. As a non-limiting example, the non-circular trajectory is an ellipsoidal, a hypotrochoid and/or an epitrochoid trajectory.

In order to drive the one or more roller guides 1022, the one or more actuators 1024 are disposed radially outboard from the one or more roller guides 1022. Additionally, the one or more actuators 1024 are integrally connected to a side of the one or more roller guides 1022 opposite the one or more rollers 1020.

Disposed radially outboard from the one or more actuators 1024 and integrally connected to an end of the one or more actuators 1024 opposite the one or more roller guides 1022, is the rotatable ring 1026. Additionally, the rotatable ring 1026 is co-axial with and at least partially radially concentric with the flywheel output shaft 1012.

As illustrated in FIG. 13, one or more inner ring connectors 1030 integrally connects the inner ring 1016 of the torque ripple compensation device 1002 to the flywheel output shaft 1012. The one or more inner ring connectors 1030 are disposed axially inboard from the one or more mechanical linkages 1028 such that at least a portion of the one or more inner ring connectors 1030 are disposed between the one or more mechanical linkages 1028 and the transmission 1006. According to an alternative embodiment of the disclosure (not shown), the one or more inner ring connectors are disposed axially outboard from the one or more mechanical linkages such that at least a portion of the one or more inner ring connectors are disposed between the one or more mechanical linkages and the flywheel.

Integrally connecting the outer ring 1018 of the torque ripple compensation device 1002 to the flywheel 1004 is one or more outer ring connectors 1032. One end of the one or more outer ring connectors 1032 is integrally connected to at least a portion of the outer ring 1016, and an end of the one or more outer ring connectors 1032 opposite the outer ring 1018, is integrally connected to at least a portion of the flywheel 1004. Additionally, the one or more outer ring connectors 1032 are disposed axially outboard from the outer ring 1016 of the torque ripple compensation device 1002 such that at least a portion of the one or more outer ring connectors 1032 is disposed between the outer ring 1016 and the flywheel 1004.

In order to obtain an optimum torque compensation, reduction and/or cancelation effect, a control system (not shown) is also used to control the torque ripple compensation device 1002. The control system (not shown) requires the use of two valves (not shown) to control the one or more actuators 1024 of the torque ripple compensation device 1002. Additionally, the control system (not shown) includes the use of one or more sensors (not shown) to determine an instantaneous axle angle in relation to a chassis (not shown) of a vehicle 1000 and a torque generated by the engine 1008.

The instantaneous axle angle is measured by using a position sensor (not shown) that monitors a plurality of teeth passing on a flywheel gearing (not shown). Additionally, the torque generated by the engine 1008 can be received using a Controller Area Network (CAN) (not shown) signal that is received from a motor Engine Control Unit (ECU) (not shown).

According to yet another embodiment of the disclosure (not shown) where the flywheel contains one or more springs that act as a damper, the torque generated by the engine can be determined by measuring the speed at an input and an output of the flywheel. In accordance with this embodiment of the disclosure (not shown), the torque generated by the engine is determined by using a sprig stiffness of the flywheel and determining the amount of torque passing through the flywheel by determining the deflection between the input and the output of the flywheel.

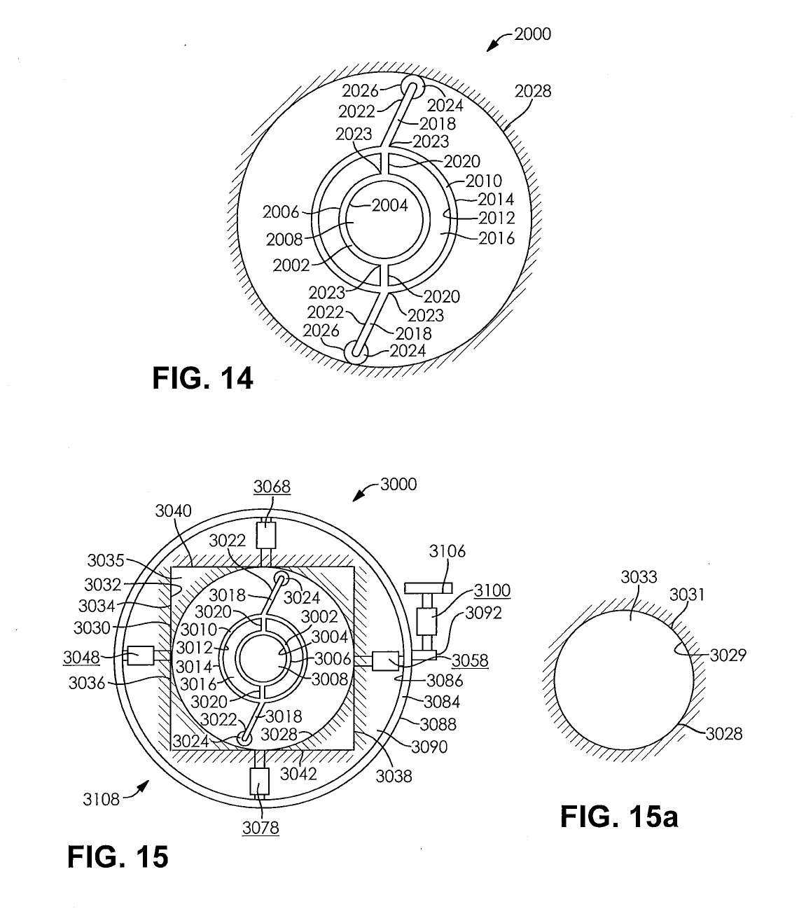

FIG. 14 is a schematic illustration of a cross-sectional side view of a portion of a torque ripple compensation device 2000 according to an embodiment of the disclosure. The torque ripple compensation device 2000 has an inner ring 2002 having an inner surface 2004 and an outer surface 2006 defining a hollow portion 2008 therein. In a non-limiting example, the inner ring 2002 is made of steel, carbon fibre or the like. At least a portion of the inner ring 2002 of the torque ripple compensation device 2000 is integrally connected to at least a portion of one or more of the following (not shown): a flywheel, a transmission, a flywheel output shaft, a transmission input shaft, a coupling shaft and/or a stub shaft.

Disposed radially outboard from and co-axial with the inner ring 2002 is an outer ring 2010 having an inner surface 2012 and an outer surface 2014 defining a hollow portion 2016 therein. In a non-limiting example, the outer ring 2010 is made of steel, carbon fibre or the like. The outer ring 2010 of the torque ripple compensation device 2000 is at least partially radially concentric with the inner ring 2002 of the torque ripple compensation device 2000. Additionally, as illustrated in FIG. 9, the outer ring 2010 has a larger diameter than the inner ring 2002. Furthermore, at least a portion of the outer ring 2010 of the torque ripple compensation device 2000 is integrally connected to at least a portion of one or more of the following (not shown): a flywheel, a transmission, a flywheel output shaft, a transmission input shaft, a coupling shaft and/or a stub shaft.

Integrally connected to the inner ring 2002 and the outer ring 2010 of the torque ripple compensation device 2000 is one or more mechanical linkages 2018 having a first end portion 2020 and a second end portion 2022. In a non-limiting example, the one or more mechanical linkages 2018 are made of steel, carbon fibre or the like. As illustrated in FIG. 14, at least a portion of the first end portion 2020 of the one or more mechanical linkages 2018 are integrally connected to the inner ring 2002 and the outer ring 2010 of the torque ripple compensation device 2000. The one or more mechanical linkages 2018 mechanically connects the inner ring 2002 to the outer ring 2010 of the torque ripple compensation device 2000. Additionally, the one or more mechanical linkages 2018 extend radially outboard from the inner ring 2002 and/or the outer ring 2010 of the torque ripple compensation device 2000. According to an embodiment of the disclosure, the one or more mechanical linkages 2018 are disposed radially transverse to the inner ring 2002 and the outer ring 2010 of the torque ripple compensation device 2000.

According to one embodiment of the disclosure, the one or more mechanical linkages 2018 are connected to the inner ring 2002 and the outer ring 2010 of the torque ripple compensation device 2000 by using one or more flexible joints 2023. According to an alternative embodiment of the disclosure (not shown) the structure of the inner ring, the outer ring and/or the one or more mechanical linkages may narrow or have a reduced thickness at the one or more flexible joints thereby allowing the structure of the torque ripple compensation device to flex easier. The flexure may be up or down, side to side or orbital. In a non-limiting example, the one or more flexible joints 2023 may be made of an elastic or a rubber material since the required angular deviation will be small. The one or more flexible joints 2023 allow a phase difference between the inner ring 2002 and the outer ring 2010 to be applied to the torque ripple compensation device 2000.

At least a portion of the second end portion 2022 of the one or more mechanical linkages 2018 are directly connected to one or more rollers 2024. In a non-limiting example, the second end portion 2022 of the one or more linkages 2018 are connected to the one or more rollers 2024 by using one or more of the following: a shaft, a linkage, a pin, a coupling shaft and/or a stub shaft. The one or more rollers 2024 are substantially circular in shape however; it is within the scope of this disclosure that the one or more rollers 2024 may be any shape that will aid in imposing a non-circular trajectory on the second end portion 2022 of the one or more mechanical linkages 2018. According to an embodiment of the disclosure, the one or more rollers 2024 are rotatively connected to at least a portion of the second end portion 2022 of the one or more mechanical linkages 2018.

At least a portion of an outer surface 2026 of the one or more rollers 2024 is in direct contact with one or more roller guides 2028. The one or more roller guides 2028 provide the outermost path that the one or more rollers 2024 can follow, thereby defining the trajectory that the one or more rollers 2024 will follow in operation. In a non-limiting example, the one or more roller guides 2028 are one or more constraints, cam shafts, inverted cam shafts, four-bar linkage systems, gear systems and/or any other mechanisms which can impose a non-circular rotational trajectory on the second end portion 2022 of the one or more mechanical linkages 2018. As a non-limiting example, the non-circular trajectory is an ellipsoidal, a hypotrochoid and/or an epitrochoid trajectory.

FIGS. 15, 16 and 17 provide a schematic cross-sectional side view of a torque ripple compensation device 3000, according to still another embodiment of the disclosure. As illustrated in FIGS. 15, 16 and 17, the torque ripple compensation device 3000 includes an inner ring 3002 having an inner surface 3004 and an outer surface 3006 defining a hollow portion 3008 therein. In a non-limiting example, the inner ring 3002 is made of steel, carbon fibre or the like. At least a portion of the inner ring 3002 of the torque ripple compensation device 3000 is integrally connected to at least a portion of one or more of the following (not shown): a flywheel, a transmission, a flywheel output shaft, a transmission input shaft, a coupling shaft and/or a stub shaft.

Disposed radially outboard from and co-axial with the inner ring 3002 is an outer ring 3010 having an inner surface 3012 and an outer surface 3014 defining a hollow portion 3016 therein. In a non-limiting example, the outer ring 3010 is made of steel, carbon fibre or the like. The outer ring 3010 of the torque ripple compensation device 3000 is at least partially radially concentric with the inner ring 3002 of the torque ripple compensation device 3000. Additionally, as illustrated in FIGS. 15, 15 and 17, the outer ring 3010 has a larger diameter than the inner ring 3002. Furthermore, at least a portion of the outer ring 3010 of the torque ripple compensation device 3000 is integrally connected to at least a portion of one or more of the following (not shown): a flywheel, a transmission, a flywheel output shaft, a transmission input shaft, a coupling shaft and/or a stub shaft.

Integrally connected to the inner ring 3002 and the outer ring 3010 of the torque ripple compensation device 3000 is one or more mechanical linkages 3018 having a first end portion 3020 and a second end portion 3022. In a non-limiting example, the one or more mechanical linkages 3018 are made of steel, carbon fibre or the like. As illustrated in FIGS. 15, 16 and 17, at least a portion of the first end portion 3020 of the one or more mechanical linkages 3018 is integrally connected to the inner ring 3002 and the outer ring 3010 of the torque ripple compensation device 3000. The one or more mechanical linkages 3018 mechanically connects the inner ring 3002 to the outer ring 3010 of the torque ripple compensation device 3000. Additionally, the one or more mechanical linkages 3018 extend radially outboard from the inner ring 3002 and/or the outer ring 3010 of the torque ripple compensation device 3000. According to an embodiment of the disclosure, the one or more mechanical linkages 3018 are disposed radially transverse to the inner ring 3002 and the outer ring 3010 of the torque ripple compensation device 3000.

According to one embodiment of the disclosure, the one or more mechanical linkages 3018 are connected to the inner ring 3002 and the outer ring 3010 of the torque ripple compensation device 3000 by using one or more flexible joints 3023. According to an alternative embodiment of the disclosure (not shown) the structure of the inner ring, the outer ring and/or the one or more mechanical linkages may narrow or have a reduced thickness at the one or more flexible joints thereby allowing the structure of the torque ripple compensation device to flex easier. The flexure may be up or down, side to side or orbital. In a non-limiting example, the one or more flexible joints 3023 may be made of an elastic or a rubber material since the required angular deviation will be small. The one or more flexible joints 3023 allow a phase difference between the inner ring 3002 and the outer ring 3010 to be applied to the torque ripple compensation device 3000.

At least a portion of the second end portion 3022 of the one or more mechanical linkages 3018 are directly connected to one or more rollers 3024. According an alternative embodiment of the disclosure, the one or more rollers 3024 are also axially offset from the inner ring 3002, the outer ring 3010 and/or the one or more mechanical linkages 3018. In a non-limiting example, the second end portion 3022 of the one or more linkages 3018 are connected to the one or more rollers 3024 by using one or more of the following: a shaft, a linkage, a pin, a coupling shaft and/or a stub shaft. The one or more rollers 3024 are substantially circular in shape however; it is within the scope of this disclosure that the one or more rollers 3024 may be any shape that will aid in imposing a non-circular trajectory on the second end portion 3022 of the one or more mechanical linkages 3018. Additionally, according to an embodiment of the disclosure, the one or more rollers 3024 are rotatively connected to at least a portion of the second end portion 3022 of the one or more mechanical linkages 3018.

At least a portion of an outer surface 3026 of the one or more rollers 3024 is in direct contact with one or more roller guides 3028 having an inner surface 3029 and an outer surface 3031 defining a hollow portion 3033 therein. As illustrated in FIGS. 15, 16 and 17, at least a portion of the outer surface 3026 of the one or more rollers 3024 are in direct contact with at least a portion of the inner surface 3029 of the one or more roller guides 3028. According to an alternative embodiment of the disclosure, the one or more roller guides 3028 are also axially offset from the inner ring 3002, the outer ring 3010 and/or the one or more mechanical linkages 3018. The one or more roller guides 3028 provide the outermost path that the one or more rollers 3024 can follow, thereby defining the trajectory that the one or more rollers 3024 and/or the second end portion 3022 of the one or more mechanical linkages 3018 will follow in operation. In a non-limiting example, the one or more roller guides 3028 are one or more constraints, cam shafts, inverted cam shafts, four-bar linkage systems, gear systems and/or any other mechanisms which can impose a non-circular rotational trajectory on the second end portion 3022 of the one or more mechanical linkages 3018. As a non-limiting example, the non-circular trajectory is an ellipsoidal, a hypotrochoid and/or an epitrochoid trajectory.

In direct contact with at least a portion of the outer surface 3031 of the one or more roller guides 3028 is one or more constraints 3030 having an inner surface 3032 and an outer surface 3034 defining a hollow portion 3035 therein. According to an alternative embodiment of the disclosure, the one or more constraints 3030 are also axially offset from the inner ring 3002, the outer ring 3010 and/or the one or more mechanical linkages 3018. As it can be seen by referencing FIGS. 15, 16 and 17, the inner surface 3032 of the one or more constraints 3030 is in direct contact with at least a portion of outer surface 3031 of the one or more roller guides 3028.

As illustrated in FIGS. 15, 16 and 17, and according to an embodiment of the disclosure, the torque ripple compensation device 3000 includes four constraints 3030 including a first vertical constraint 3036 a second vertical constraint 3038, a first horizontal constraint 3040 and a second horizontal constraint 3042.

The first vertical constraint 3036 has an inner surface 3044 and an outer surface 3046 and is horizontally or axially movable by one or more first axial actuators 3048 having a first end portion 3050 and a second end portion 3052. At least a portion of the inner surface 3044 of the first vertical constraint 3036 is in direct contact with at least a portion of the outer surface 3031 of the one or more roller guides 3028. Additionally, at least a portion of the outer surface 3046 of the first vertical constraint 3036 is integrally connected to at least a portion of the second end portion 3052 of the one or more first axial actuators 3048. The one or more first axial actuators 3048 are substantially horizontal in relation to the first vertical constraint 3036 such that the one or more first axial actuators 3048 are substantially perpendicular to the first vertical constraint 3036. According to an alternative embodiment of the disclosure, the one more first axial actuators 3048 are axially offset from the inner ring 3002, the outer ring 3010 and/or the one or more mechanical linkages 3018.

As illustrated in FIGS. 15, 16 and 17, the second vertical constraint 3038 has an inner surface 3054 and an outer surface 3056 and is horizontally or axially movable by one or more second axial actuators 3058 having a first end portion 3060 and a second end portion 3062. At least a portion of the inner surface 3054 of the second vertical constraint 3038 is in direct contact with at least a portion of the outer surface 3031 of the one or more roller guides 3028. Additionally, at least a portion of the outer surface 3056 of the second vertical constraint 838 is integrally connected to at least a portion of the first end portion 3060 of the one or more second horizontal actuators 3058. The one or more second axial actuators 3058 are substantially horizontal in relation to the second vertical constraint 3038 such that the one or more second axial actuators 3058 are substantially perpendicular to the second vertical constraint 3038. Furthermore, vertical constraints 3036 and 3038 are disposed on axially opposing sides of the one or more roller guides 3028 and are substantially parallel to each other. According to an alternative embodiment of the disclosure, the one more second axial actuators 3058 are axially offset from the inner ring 3002, the outer ring 3010 and/or the one or more mechanical linkages 3018.

The first horizontal constraint 3040 has an inner surface 3064 and an outer surface 3066 and is vertically or radially movable by one or more first radial actuators 3068 having a first end portion 3070 and a second end portion 3072. At least a portion of the inner surface 3064 of the first horizontal constraint 3040 is in direct contact with at least a portion of the outer surface 3031 of the one or more roller guides 3028. Additionally, at least a portion of the outer surface 3066 of the first horizontal constraint 3040 is integrally connected to at least a portion of the second end portion 3072 of the one or more first radial actuators 3068. The one or more first radial actuators 3068 are substantially vertical in relation to the first horizontal constraint 3040 such that the one or more first radial actuators 3068 are substantially perpendicular to the first horizontal constraint 3040. According to an alternative embodiment of the disclosure, the one or more first radial actuators 3068 are axially offset from the inner ring 3002, the outer ring 3010 and/or the one or more mechanical linkages 3018.

As illustrated in FIGS. 15, 16 and 17, the second horizontal constraint 3042 has an inner surface 3074 and an outer surface 3076 and is vertically or radially movable by one or more second radial actuators 3078 having a first end portion 3080 and a second end portion 3082. At least a portion of the inner surface 8304 of the second horizontal constraint 3042 is in direct contact with at least a portion of the outer surface 3031 of the one or more roller guides 3028. Additionally, at least a portion of the outer surface 3076 of the second horizontal constraint 3042 is integrally connected to at least a portion second end portion 3082 of the second radial actuator 3078. The one or more second radial actuators 3078 are substantially vertical in relation to the second horizontal constraint 3042 such that the one or more second radial actuators 3078 are substantially perpendicular to the second horizontal constraint 3042. Furthermore, horizontal constraints 3040 and 3042 are disposed on radially opposing sides of the one or more roller guides 3028 and are substantially parallel to each other. According to an alternative embodiment of the disclosure, the one or more first radial actuators 3068 are axially offset from the inner ring 3002, the outer ring 3010 and/or the one or more mechanical linkages 3018.

Co-axial with but at least partially axially offset from the inner ring 3002 and the outer ring 3010 is a rotatable ring 3084 having an inner surface 3086 and an outer surface 3088 defining a hollow portion 3090 therein. At least a portion of the first end portion 3050 of the one or more first axial actuator 3048 and at least a portion of the second end portion 3062 of the one or more second axial actuator 3058 is integrally connected to at least a portion of the inner surface 3086 of the rotatable ring 3084. Similarly, at least a portion of the first end portion 3070 of the one or more first radial actuators 3068 and at least a portion of the first end portion 3080 of the one or more second radial actuators 3078 are integrally connected to at least a portion of the inner surface 3086 of the rotatable ring 3084.

According to an alternative embodiment of the disclosure (not shown), the one or more first axial actuators, second axial actuators, first radial actuators and/or second radial actuators are integrally connected to the one or more roller guides without the use of the first vertical constraint, the second vertical constraint, the first horizontal constraint and/or the second horizontal constraint.

A rotatable ring connector 3092 having a first end portion 3094, a second end portion 3096 and an outer surface 3098 is integrally connected to at least a portion of the outer surface 3088 of the rotatable ring 3084. As illustrated in FIGS. 15, 16 and 17, at least a portion of the first end portion 3094 of the rotatable ring connector 3092 is integrally connected to at least a portion of the outer surface 3088 of the rotatable ring 3084.

In order to rotate the rotatable ring, a rotatable ring rotating device is used. According to an embodiment of the disclosure, the rotatable ring rotating device is an orientation actuator 900 having a first end portion 902 and a second end portion 904. As illustrated in FIGS. 15, 16 and 17, at least a portion of the first end portion 3102 of the orientation actuator 3100 is integrally connected to at least a portion of the outer surface 3098 of the rotatable ring connector 3092. According to an embodiment of the disclosure, the first end portion 3102 of the orientation actuator 3100 is pivotally connected to at least a portion of the outer surface 3098 or the rotatable ring connector 3092. The second end portion 3104 of the orientation actuator 3100 is integrally connected to a portion of a vehicle chassis 3106. According to an embodiment of the disclosure, the second end portion 3104 of the orientation actuator 3100 is pivotally connected to at least a portion of the vehicle chassis 3106.

In accordance with an alternative embodiment of the disclosure (not shown), at least a portion of the first end portion of the orientation actuator is integrally connected to at least a portion of the outer surface of the rotatable ring. According to yet another embodiment of the disclosure (not shown), at least a portion of the first end portion of the orientation actuator is pivotally connected to at least a portion of the outer surface of the rotatable ring. Furthermore, in accordance with still another embodiment of the disclosure (not shown), the rotatable ring rotating device is not the orientation actuator previously discussed, but is an electric motor that acts upon at least a portion of the outer surface of the rotatable ring to rotate the rotatable ring.

According to yet another alternative embodiment of the disclosure (not shown), the rotatable ring is not rotatable. In accordance with this embodiment of the disclosure (not shown), at least a portion of the outer surface of the rotatable ring is integrally connected to at least a portion of the chassis of the vehicle.

When the torque ripple compensation device 3000 is in a first position 3108 illustrated in FIG. 15, the first vertical constraint 3036, the second vertical constraint 3038, the first horizontal constraint 3040 and the second horizontal constraint 3042 are not acting upon the one or more roller guides 3028 and/or the one or more rollers 3024. According to an embodiment of the disclosure, when in the first position 3108, the one or more first axial actuators 3048, the one or more second axial actuators 3058, the one or more first radial actuators 3068 and the one or more second radial actuators 3078 are fully retracted and in their home position. As illustrated in FIGS. 15 and 15a, when the first vertical constraint 3036, the second vertical constraint 3038, the first horizontal constraint 3040 and the second horizontal constraint 3042 are not acting upon the one or more rollers 3024, the one or more roller guides 3028 have a substantially circular shape. As a result, the shape of the trajectory of the first end portion 3020 of the one or more mechanical linkages 3018 is not altered and a zero angular difference is imposed between the inner ring 3002 and the outer ring 3010 thereby resulting in zero torque spike, torque pulse and/or torque ripple compensation, reduction and/or cancelation.

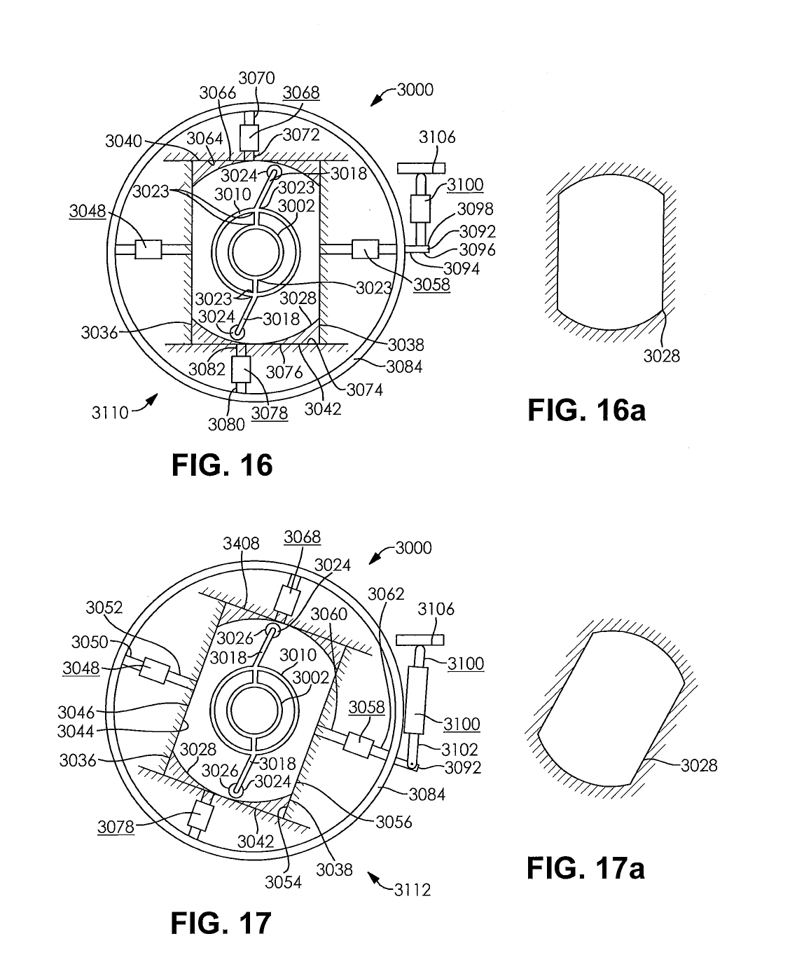

In contrast, when the torque ripple compensation device 3000 is in a second position 3110 illustrated in FIG. 16, the one or more first axial actuators 3048 and/or the one or more second axial actuators 3058 extend thereby acting upon the one or more rollers 3024 and/or the first end portion 3020 of the one or more mechanical linkages 3018. As illustrated in FIGS. 16 and 16a, when the first and the second vertical constraints 3036 and 3038 are acting upon the one or more roller guides 3028 and/or the one or more rollers 3024, the one or more roller guides 3028 have a non-circular shape. As a result, the shape of the trajectory of the first end portion 3020 of the one or more mechanical linkages 3018 is altered and a non-zero angular difference Δα(t) is imposed between the inner ring 3002 and the outer ring 3010 thereby resulting in amplitude torque spike, torque pulse and/or torque ripple compensation, reduction and/or cancelation.

Finally, when the torque ripple compensation device 3000 is in a third position 3112 illustrated in FIG. 17, the one or more first axial actuators 3048 and/or the one or more second axial actuators 3058 extend thereby acting upon the one or more rollers 3024 and/or the first end portion 3020 of the one or more mechanical linkages 3018. Additionally, when in the third position 3102, the orientation actuator 3100 extends and rotates the rotatable ring 3084 thereby altering the orientation of the first and second vertical constraints 3036 and 3038, the first and second horizontal constraints 3040 and 3042, the one or more first and second axial actuators 3048 and 3058, the one or more first and second radial actors 3068 and 3078 and/or the one or more roller guides 3028 imposing a phase angle.

As illustrated in FIGS. 17 and 17a, when the first and second vertical constraints 3036 and 3038 are acting upon the one or more roller guides 3028 and/or the one or more rollers 3024 of the one or more mechanical linkages 3018, the one or more roller guides 3028 have a non-circular shape. Furthermore, when the orientation actuator 3100 extends and rotates the rotatable ring 3084, it alters the orientation of the one or more roller guides 3028. As a result, the shape and the orientation of the trajectory of the first end portion 3020 of the one or more mechanical linkages 3018 is altered and a non-zero angular difference Δα(t) is imposed between the inner ring 3002 and the outer ring 3010 thereby resulting in both amplitude and phase torque spike, torque pulse and/or torque ripple compensation, reduction and/or cancelation.

It is within the scope of the present disclosure that the first and second vertical constraints 3036 and 3038, the first and second horizontal constraints 3040 and 3042 and/or the orientation actuator 3100 may independently or in combination act upon the one or more roller guides 3028 and/or the one or more rollers 3024 of the first end portion 3020 of the one or more mechanical linkages 3018. As a result, the torque ripple compensation device 3000 according to the present disclosure, is able to impose any non-circular trajectory on an/or alter the orientation of the trajectory of the first end portion 3020 of the one or more linkages 3018. This allows the torque ripple compensation device 3000 to independently control both the amplitude and/or the phase of a torque spike, torque pulse and/or a torque ripple.

In order to obtain an optimum torque compensation, reduction and/or cancelation effect, a control system (not shown) is also used to control the torque ripple compensation device 3000. The control system (not shown) requires the use of two valves (not shown) to control the one or more actuators 3048, 3058, 3068, 3078 and 3100 of the torque ripple compensation device 3000. Additionally, the control system (not shown) includes the use of one or more sensors (not shown) to determine an instantaneous axle angle in relation to a chassis (not shown) of a vehicle (not shown) and a torque generated by the engine (not shown).

The instantaneous axle angle is measured by using a position sensor (not shown) that monitors a plurality of teeth passing on a flywheel gearing (not shown). Additionally, the torque generated by the engine (not shown) can be received using a Controller Area Network (CAN) (not shown) signal that is received from a motor Engine Control Unit (ECU) (not shown).

According to yet another embodiment of the disclosure (not shown) where the flywheel contains one or more springs that act as a damper, the torque generated by the engine can be determined by measuring the speed at an input and an output of the flywheel. In accordance with this embodiment of the disclosure (not shown), the torque generated by the engine is determined by using a sprig stiffness of the flywheel and determining the amount of torque passing through the flywheel by determining the deflection between the input and the output of the flywheel.

In accordance with the provisions of the patent statutes, the present invention has been described to represent what is considered to represent the preferred embodiments. However, it should be noted that this invention can be practiced in other ways than those specifically illustrated and described without departing from the spirit or scope of this invention.

What is claimed is:

1. A method of canceling torque spikes in a rotating shaft using a torque spike cancellation device, wherein said torque spike cancellation device comprises an outer ring and an inner ring that is co-axial with said outer ring, one or more linkages having a first end portion and a second end portion, wherein said first end portion of said one or more linkages is in direct contact with one or more constraints and said second end portion of said one or more linkages is connected to said inner ring and said outer ring, said method comprising:
identifying a torque spike on a rotating shaft;
calculating an amplitude of said torque spike;
comparing said calculated amplitude of said torque spike to a pre-determined torque profile;
calculating an amount of amplitude shift from said pre-determined torque profile;
determining a non-circular trajectory needed to cancel said amount of amplitude shift calculated;
applying a force to said first end portion of said one or more linkages to cancel said amplitude shift of said torque spike.

2. The method of cancelling torque spikes of claim 1, further comprising:
calculating a phase of said torque spike;
comparing said calculated phase of said torque spike to a pre-determined torque profile;
calculating an amount of phase shift from said pre-determined torque profile;
determining a non-circular trajectory orientation needed to cancel said amount of phase shift calculated; and
applying a force to said first end portion of said one or more mechanical linkages to cancel said phase shift of said torque spike.

3. The method of canceling torque spikes of claim 1, wherein said non-circular trajectory is an ellipsoidal, hypotrochoid and/or epitrochoid trajectory and wherein said non-circular trajectory orientation is an ellipsoidal, hypotrochoid and/or epitrochoid trajectory orientation.

4. The method of canceling torque spikes of claim 1, wherein said force applied to said first end portion of said one or more linkages imposes a time-varying angular difference Δα(t) between said inner ring and said outer ring.

5. A method of canceling torque spikes in a rotating shaft using a torque spike cancellation device, wherein said torque spike cancellation device comprises an outer ring and an inner ring that is co-axial with said outer ring, one or more linkages having a first end portion and a second end portion, wherein said first end portion of said one or more linkages is in direct contact with one or more constraints and said second end portion of said one or more linkages is connected to said inner ring and said outer ring, said method comprising:
identifying a torque spike on a rotating shaft;
calculating an amplitude of said torque spike;
calculating a phase of said torque spike;
comparing said calculated amplitude and said calculated phase of said torque spike to a pre-determined torque profile;
calculating an amount of amplitude shift and phase shift from said pre-determined torque profile;
determining a non-circular trajectory needed to cancel said amount of amplitude shift calculated;
determining a non-circular trajectory orientation needed to cancel said amount of phase shift calculated; and
applying a force to said first end portion of said one or more linkages to cancel said phase shift and/or said amplitude shift of said torque spike.

6. The method of canceling torque spikes of claim 5, wherein said non-circular trajectory is an ellipsoidal, hypotrochoid and/or epitrochoid trajectory and wherein said non-circular trajectory orientation is an ellipsoidal, hypotrochoid and/or epitrochoid trajectory orientation.

7. The method of canceling torque spikes of claim 5, wherein said force applied to said first end portion of said one or more linkages imposes a time-varying angular difference Δα(t) between said inner ring and said outer ring.

8. A torque spike compensation device, comprising:
an inner ring having an inner surface and an outer surface defining a hollow portion therein;
an outer ring having an inner surface and an outer surface defining a hollow portion therein;
wherein said outer ring has a larger diameter than said inner ring;
wherein said outer ring is co-axial with said inner ring;
wherein said outer ring is disposed radially outboard from said inner ring such that at least a portion of said outer ring is radially concentric with said inner ring;
one or more mechanical linkages having a first end portion and a second end portion;
wherein said one or more mechanical linkages extend radially transversally to said inner ring and said outer ring;
wherein at least a portion of said first end portion of said one or more mechanical linkages are rotatably connected to one or more rollers having an outer surface;
wherein at least a portion of said second end portion of said one or more mechanical linkages is integrally connected to at least a portion of said inner ring and said outer ring;
wherein said first end portion of said one or more mechanical linkages extends radially from said inner ring and said outer ring;
one or more roller guides having an inner surface and an outer surface defining a hollow portion therein;
wherein at least a portion of said inner surface of said one or more roller guides is in direct contact with at least a portion of said outer surface of said one or more rollers;
a first vertical constraint having an inner surface and an outer surface;
wherein at least a portion of said inner surface of said first vertical constraint is in direct contact with at least a portion of said outer surface of said one or more roller guides;
a second vertical constraint having an inner surface and an outer surface;
wherein at least a portion of said inner surface of said second vertical constraint is, in direct contact with at least a portion of said outer surface of said one or more roller guides;
wherein said first vertical constraint and said second vertical constraint are disposed on axially opposing sides of said one or more roller guides;
a first horizontal constraint having an inner surface and an outer surface;
wherein at least a portion of said inner surface of said first horizontal constraint is in direct contact with at least a portion of said outer surface of said one or more roller guides;
a second horizontal constraint having an inner surface and an outer surface;
wherein at least a portion of said inner surface of said second horizontal constraint is in direct contact with at least a portion of said outer surface of said one or more roller guides;
wherein said first horizontal constraint and said second horizontal constraint are disposed on radially opposing sides of said one or more roller guides;
a rotatable ring having an inner surface and an outer surface defining a hollow portion therein;
wherein said rotatable ring has a larger diameter than said inner ring and said outer ring;
wherein said rotatable ring is co-axial with said inner ring and said outer ring;
wherein said rotatable ring is disposed radially outboard from said inner ring and said outer ring;
one or more first axial actuators having a first end portion and a second end portion;
wherein at least a portion of said first end portion of said one or more first axial actuators is integrally connected to at least a portion of said inner surface of said rotatable ring;
wherein at least a portion of said second end portion of said one or more first axial actuators is integrally connected to said outer surface of said first vertical constraint;
one or more second axial actuators having a first end portion and a second end portion;
wherein at least a portion of said first end portion of said one or more second axial actuators is integrally connected to at least a portion of said outer surface of said second vertical constraint;
wherein at least a portion of said second end portion of said one or more second axial actuators is integrally connected to at least a portion of said inner surface of said rotatable ring;
one or more first radial actuators having a first end portion and a second end portion;
wherein at least a portion of said first end portion of said one or more first radial actuators is integrally connected to at least a portion of said inner surface of said rotatable ring;
wherein at least a portion of said second end portion of said one or more first radial actuators is integrally connected to at least a portion of said outer surface of said first horizontal constraint;
one or more second radial actuators having a first end portion and a second end portion;
wherein at least a portion of said first end portion of said one or more second radial actuators is integrally connected to at least a portion of said inner surface of said rotatable ring; and
wherein at least a portion of said second end portion of said one or more second radial actuators is integrally connected to at least a portion of said outer surface of said second horizontal constraint.

9. The torque spike compensation device of claim 8, further comprising:
a rotatable ring rotating device having a first end portion and a second end portion;
wherein a least a portion of said first end portion of said rotatable ring rotating device is drivingly connected to at least a portion of said outer surface of said rotatable ring; and
wherein at least a portion of said second end portion of said rotatable ring rotating device is integrally connected to a portion of a vehicle chassis.

10. The torque spike compensation device of claim 9, wherein said rotatable ring rotating device is an orientation actuator and/or an electric motor.

11. The torque spike compensation device of claim 10, wherein said inner ring, said outer ring and/or said one or more mechanical linkages is made of steel or a carbon fibre material.

12. The torque spike compensation device of claim 8, wherein said outer ring is integrally connected to at least a portion of a flywheel and said inner ring is integrally connected to a flywheel output shaft, a transmission input shaft and/or a coupling shaft.

13. The torque spike compensation device of claim 8, further comprising: one or more flexible joints;
wherein said one or more flexible joints integrally connects at least a portion of said inner surface and at least a portion of said outer surface of said inner ring to at least a portion of said second end portion of said one or more mechanical linkages;
wherein said one or more flexible joints integrally connects said at least a portion of said inner surface of said outer ring to at least a portion of said second end portion od said one or more mechanical linkages; and
wherein said one or more flexible joints are made of an elastic or a rubber material.

14. The torque spike compensation device of claim 8, wherein said first end portion of said one or more mechanical linkages extends radially outboard from said inner ring and said outer ring.

15. The torque spike compensation device of claim 8, wherein said first end portion of said one or more mechanical linkages extends radially inboard from said inner ring and said outer ring.

16. The torque spike cancellation device of claim 15, further comprising:
a lay shaft having a first end portion and a second end portion;
wherein said lay shaft is disposed radially outboard from said outer surface of said outer ring;
a first gear having a plurality of teeth circumferentially extending from at least a portion of an outer surface of said first gear is integrally connected to at least a portion of said first end portion of said lay shaft;
wherein said plurality of teeth circumferentially extending from at least a portion of said outer surface of said first gear are complementary to and meshingly engaged with a plurality of teeth circumferentially extending from at least a portion of an outer surface of a flywheel;
a second gear having a plurality of teeth circumferentially extending from at least a portion of an outer surface of said second gear is integrally connected to at least a portion of said second end portion of said lay shaft; and
wherein said plurality of teeth circumferentially extending from at least a portion of said outer surface of said second gear are complementary to and meshingly engaged with a plurality of teeth circumferentially extending from at least a portion of said outer surface of said outer ring.
